(19) United States
(12) Patent Application Publication
(10) Pub. No.: US 2024/0373219 A1
(43) Pub. Date: Nov. 7, 2024

(54) METHOD FOR SELECTING SECURITY ALGORITHM IN AUTHENTICATION PROCEDURE OF WIRELESS COMMUNICATION NETWORK

(71) Applicant: Samsung Electronics Co., Ltd., Suwon-si (KR)

(72) Inventors: Hongjin CHOI, Suwon-si (KR); Taehyung LIM, Suwon-si (KR); Junhyun PARK, Suwon-si (KR)

(21) Appl. No.: 18/636,812

(22) Filed: Apr. 16, 2024

(30) Foreign Application Priority Data
Apr. 21, 2023 (KR) 10-2023-0052782

(51) Int. Cl. H04W 12/06; H04W 12/041; H04W 12/72; H04W 36/00; H04W 60/04

(52) U.S. Cl. CPC H04W 12/06; H04W 12/041; H04W 12/72; H04W 36/0038; H04W 60/04

(57) ABSTRACT

The disclosure relates to a fifth generation (5G) or sixth generation (6G) communication system for supporting a higher data transmission rate. A method performed by a user equipment (UE) for performing network authentication is provided. The method includes determining, by the UE, a K-bit identification indicator indicating whether a length of an authentication key (K) stored in a subscriber identification module (SIM) is identified, selecting, by the UE, at least one security algorithm based on the K-bit identification indicator, and transmitting, by the UE to a network device, a registration request message including the K-bit identification indicator and information about the at least one security algorithm.

### CROSS-REFERENCE TO RELATED APPLICATION(S)

This application is based on and claims priority under 35 U.S.C. § 119 (a) of a Korean patent application number 10-2023-0052782, filed on Apr. 21, 2023, in the Korean Intellectual Property Office, the disclosure of which is incorporated by reference herein in its entirety.

### BACKGROUND

### 1. Field

The disclosure relates to a method and device for selecting a security algorithm in an authentication procedure of a wireless communication network.

### 2. Description of Related Art

Fifth generation (5G) mobile communication technologies define broad frequency bands such that high transmission rates and new services are possible, and can be implemented not only in “Sub 6 gigahertz (GHZ)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 terahertz (TH) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step Random Access Channel (RACH) for New Radio (NR)). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

For non-access stratum (NAS) and access stratum (AS) security between a user equipment (UE) and a network, security algorithms (e.g., ciphering algorithm and integrity protection algorithm) may be used. For example, an access and mobility management function (AMF) and a base station (e.g., next generation node B (gNB)) may generate various session keys required for security with the UE using an anchor key (e.g., K_{SEAF}) derived from an authentication key K and a security algorithm.

The above information is presented as background information only to assist with an understanding of the disclosure. No determination has been made, and no assertion is made, as to whether any of the above might be applicable as prior art with regard to the disclosure.

### SUMMARY

Due to the development of computing technology, it is necessary to use not only 128 bit-based security algorithms, but also 256 bit-based security algorithms that may provide a higher level of security. Use of a 256 bit-based security algorithm for security of the UE and the network requires that the UE support the 256 bit-based security algorithm and the length of the authentication key K stored in the universal subscriber identity module (USIM) of the UE be 256 bits. Although the UE and the network are able to support the 256 bit-based security algorithm, if the length of K present in the USIM of the UE is 128 bits, the use of the 256 bit-based security algorithm unnecessarily increase the computation load, but has no influence on increasing the security level.

Aspects of the disclosure are to address at least the above-mentioned problems and/or disadvantages and to provide at least the advantages described below. Accordingly, an aspect of the disclosure is to provide a method and device for using a security algorithm based on a length of 256 bits or more for security of the UE and the network.

Additional aspects will be set forth in part in the description which follows and, in part, will be apparent from the description, or may be learned by practice of the presented embodiments.

In accordance with an aspect of the disclosure, a method performed by a user equipment (UE) for performing network authentication is provided. The method includes determining, by the UE, a K-bit identification indicator indicating whether a length of an authentication key (K) stored in a subscriber identification module (SIM) is identified, selecting, by the UE, at least one security algorithm based on the K-bit identification indicator, and transmitting, by the UE to a network device, a registration request message including the K-bit identification indicator and information about the at least one security algorithm.

In accordance with another aspect of the disclosure, a method performed by a network device to select a non-access stratum (NAS) security algorithm with a user equipment (UE) is provided. The method includes receiving, by the network device from the UE, a registration request message including information about at least one security algorithm and a K-bit identification indicator indicating whether the UE identifies a length of an authentication key (K), identifying, by the network device, information about the length of the authentication key based on the information about the at least one security algorithm and the K-bit identification indicator, obtaining, by the network device from an authentication server, the information about the length of the authentication key based on the length of the authentication key not being identified, and determining, by the network device, an NAS ciphering algorithm and an NAS integrity protection algorithm based on information about the length of the authentication key, information about the at least one security algorithm, and information about a security algorithm priority of the network device.

In accordance with another aspect of the disclosure, a method performed by a base station to select an access stratum (AS) security algorithm with a user equipment (UE) is provided. The method includes forwarding, by the base station to a network device, a registration request message received from the UE, receiving, by the base station from the network device, information about at least one security algorithm available to the UE and information about a length of an authentication key of the UE, selecting, by the base station, an AS ciphering algorithm and an AS integrity protection algorithm based on the information about the at least one security algorithm, the information about the length of the authentication key, and information about a security algorithm priority of the base station, and transmitting, by the base station to the UE, information about the selected AS ciphering algorithm and information about the selected AS integrity protection algorithm.

In accordance with another aspect of the disclosure, a user equipment (UE) for performing network authentication is provided. The user equipment includes a subscriber identification module (SIM), communication circuitry, memory storing one or more computer programs, and one or more processors communicatively coupled to the SIM, the communication circuitry, and the memory. The one or more computer programs include computer-executable instructions that, when executed by the one or more processors, cause the UE to determine a K-bit identification indicator indicating whether a length of an authentication key (K) stored in the SIM is identified, select at least one security algorithm based on the K-bit identification indicator, and transmit, through the communication circuitry to a network device, a registration request message including the K-bit identification indicator and information about the at least one security algorithm.

In accordance with another aspect of the disclosure, a network device to select a non-access stratum (NAS) security algorithm with a user equipment (UE) is provided. The network device includes communication circuitry, memory storing one or more computer programs, and one or more processors communicatively coupled to the communication circuitry and the memory. The one or more computer programs include computer-executable instructions that, when executed by the one or more processors, cause the network device to receive, from the UE, a registration request message including information about at least one security algorithm and a K-bit identification indicator indicating whether the UE identifies a length of an authentication key (K), identify information about the length of the authentication key based on the information about the at least one security algorithm and the K-bit identification indicator, obtain the information about the length of the authentication key from an authentication server based on the length of the authentication key not being identified, and determine an NAS ciphering algorithm and an NAS integrity protection algorithm based on information about the length of the authentication key, information about the at least one security algorithm, and information about a security algorithm priority of the network device.

In accordance with another aspect of the disclosure, a base station to select an access stratum (AS) security algorithm with a user equipment (UE) is provided. The base station includes communication circuitry, memory storing one or more computer programs, and one or more processors communicatively coupled to the communication circuitry and the memory. The one or more computer programs include computer-executable instructions that, when executed by the one or more processors, cause the base station to forward, to a network device through the communication circuitry, a registration request message received from the UE, receive, from the network device through the communication circuitry, information about at least one security algorithm available to the UE and information about a length of an authentication key of the UE, select an AS ciphering algorithm and an AS integrity protection algorithm based on the information about the at least one security algorithm, the information about the length of the authentication key, and information about a security algorithm priority of the base station, and transmit, to the UE through the communication circuitry, information about the selected AS ciphering algorithm and information about the selected AS integrity protection algorithm.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include determining, by the UE, a K-bit identification indicator indicating whether a length of an authentication key (K) stored in a subscriber identification module (SIM) is identified, selecting, by the UE, at least one security algorithm based on the K-bit identification indicator, and transmitting, by the UE to a network device, a registration request message including the K-bit identification indicator and information about the at least one security algorithm.

Embodiments of the disclosure effectively selects a security algorithm required for non-access stratum (NAS) and access stratum (AS) protection in a wireless communication network.

Embodiments of the disclosure also render it possible to adaptively select a security algorithm considering the security capability of the UE and the length of the authentication key of the universal subscriber identity module (USIM) in selecting a security algorithm in a wireless communication network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a wireless communication network according to an embodiment of the disclosure;

FIG. 1B illustrates a wireless environment including a core network (CN) in a wireless communication system according to an embodiment of the disclosure;

FIG. 2A illustrates an example of a functional structure of a UE according to an embodiment of the disclosure;

FIG. 2B illustrates an example of a functional structure of a base station according to an embodiment of the disclosure;

FIG. 2C illustrates an example of a functional structure of an entity constituting a core network according to an embodiment of the disclosure;

FIG. 3A illustrates an example of derivation and distribution of a key through network entities according to an embodiment of the disclosure;

FIG. 3B illustrates an example of derivation and distribution of a key through a UE according to an embodiment of the disclosure;

FIG. 4 illustrates an example of signaling flow for authentication and security configuration between a UE and network entities according to an embodiment of the disclosure;

FIG. 5 illustrates an operation flow of a UE according to an embodiment of the disclosure;

FIG. 6 illustrates an operation flow of a network device according to an embodiment of the disclosure;

FIG. 7 illustrates an operation flow of a base station according to an embodiment of the disclosure;

FIG. 8 illustrates a signaling flow between entities in an Xn handover process according to an embodiment of the disclosure;

FIG. 9 illustrates an operation flow of a base station according to an embodiment of the disclosure;

FIG. 10 illustrates an operation flow of a network device according to an embodiment of the disclosure;

FIG. 11 illustrates a signaling flow between entities in an N2 handover process according to an embodiment of the disclosure;

FIG. 12 illustrates an operation flow of a network device according to an embodiment of the disclosure;

FIG. 13 illustrates an operation flow of a base station according to an embodiment of the disclosure; and

FIG. 14 illustrates an example of UE security capability information according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the disclosure. As used herein, ‘ciphering algorithm’ may be interchangeably used with ‘encryption algorithm.’

Methods described below in connection with embodiments are based on hardware. However, embodiments of the disclosure encompass technology using both hardware and software and thus do not exclude software-based methods.

The 3rd generation partnership project (3GPP), which is in charge of cellular mobile communication standardization, has named the new core network structure 5G core (5GC) and standardized the same to promote the evolution from the legacy fourth generation (4G) long term evolution (LTE) system to the 5G system. 5GC supports the following differentiated functions as compared to the evolved packet core (EPC), which is the legacy network core for 4G.

First, 5GC adopts the network slicing function. As a requirement for 5G, 5GC should support various types of UE types and services (e.g., eMBB, URLLC, or mMTC services). Various types of services have different requirements for the core network. For example, the eMBB service requires a high data rate while the URLLC service requires high stability and low latency. Network slicing is technology proposed to meet such various requirements.

Network slicing is a method for creating multiple logical networks by virtualizing one physical network, and the network slice instances (NSIs) may have different characteristics. Therefore, various service requirements may be met by allowing each NSI to have a network function (NF) suited for its characteristics. Various 5G services may be efficiently supported by allocating an NSI meeting service characteristics required for each UE.

Second, 5GC may seamlessly support the network virtualization paradigm by separating the mobility management function and the session management function (SMF). In legacy 4G long term evolution (LTE), services may be received through signaling exchange with a single core device called the mobility management entity (MME) in charge of registration, authentication, mobility management and session management functions for all UEs. However, in 5G, the number of UEs explosively increases and mobility and traffic/session characteristics that need to be supported according to the type of UE are subdivided. Resultantly, if all functions are supported by a single device, such as MME, the scalability of adding entities for each required function may decrease. Accordingly, various functions are under development based on a structure that separates the mobility management function and the session management function to enhance the scalability in terms of function/implementation complexity of the core equipment in charge of the control plane and the signaling load.

Hereinafter, embodiments of the disclosure are described in detail with reference to the accompanying drawings. When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in computer-available or computer-readable memory that may be oriented to a computer or other programmable data processing devices to implement a function in a specified manner, the instructions stored in the computer-available or computer-readable memory may produce a product including instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit may play a certain role. However, ‘unit’ is not limited to software or hardware. A ‘unit’ may be configured in a storage medium that may be addressed or may be configured to execute one or more processors. Accordingly, as an example, a ‘unit’ may include elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

Hereinafter, the base station may be an entity allocating resource to terminal and may be at least one of eNodeB (eNB), Node B, base station (BS), radio access network (RAN), access network (AN), RAN node, NR NB, gNB, wireless access unit, base station controller, or node over network. The terminal may include user equipment (UE), mobile station (MS), cellular phone, smartphone, computer, or multimedia system capable of performing communication functions. In various embodiments of the disclosure, an example in which the terminal is a UE is described. Although LTE, long term evolution advanced (LTE-A), or NR based systems are described as examples in connection with embodiments of the disclosure, various embodiments of the disclosure may also apply to other communication systems with a similar technical background or channel form. Further, various embodiments of the disclosure may be modified in such a range as not to significantly depart from the scope of the disclosure under the determination by one of ordinary skill in the art and such modifications may be applicable to other communication systems.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings. Further, although the disclosure describes various embodiments using terms used in some communication standards (e.g., 3rd generation partnership project (3GPP)), this is merely an example for description. Various embodiments of the disclosure may be easily modified and applied in other communication systems.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

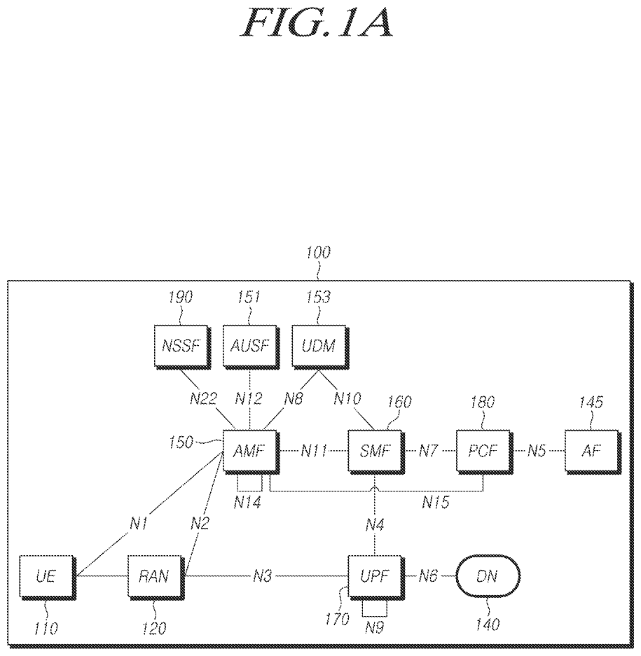

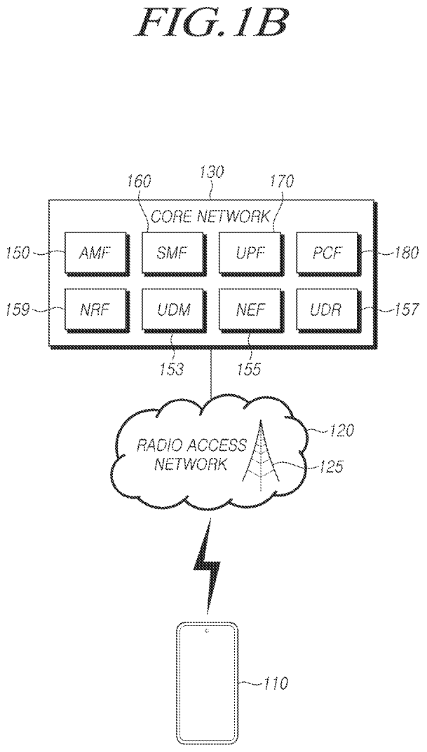

FIG. 1A illustrates a wireless communication network according to an embodiment of the disclosure.

Referring to FIG. 1A, a wireless communication network 100 may include a user equipment (UE) 110, a radio access network (RAN) 120, and/or a core network including core network entities (e.g., AMF 150, SMF 160, and UPF 170).

The core network may include a plurality of network entities, such as an access and mobility management function (AMF) 150 that provides a mobility management function of the UE, a session management function (SMF) 160 that provides a session management function, a user plane function (UPF) 170 that performs a data transfer role, a policy control function (PCF) 180 that provides a policy control function, a unified data management (UDM) 153 that provides data management functions, such as for subscriber data and policy control data, and unified data repository (UDR) (e.g., UDR 157 of FIG. 1B) that stores such various network functions.

Referring to FIG. 1A, a UE 110 may communicate with core network entities through a base station (BS) (e.g., eNB or gNB). The UE 110 is a device used by the user and may include a device configured to provide a user interface (UI). For example, the UE 110 may include a UE equipped in a vehicle for driving. For example, the UE 110 may be a device that performs machine type communication (MTC) that operates without user involvement, or may include an autonomous vehicle. UE may also be denoted by other terms, such as terminal, vehicle terminal, user equipment (UE), mobile station, subscriber station, remote terminal, wireless terminal, user device, as well as electronic device 101, or by other various terms with equivalent technical meanings thereto. As the terminal, a customer-premises equipment (CPE) or a dongle-type terminal, other than the UE, may be used. Meanwhile, the customer-premises equipment may be connected to a next generation (NG)-RAN node and provide a network to other communication equipment (e.g., a laptop computer).

The AMF 150 may provide functions for access and mobility management in units of the UE 110. One UE 110 may be connected to one AMF 150. The AMF 150 may perform at least one function among signaling between core network nodes for mobility between 3GPP access networks, an interface (e.g., N2 interface) between radio access networks (e.g., 5G RAN) 120, non-access stratum (NAS) signaling with the UE 110, identification of the SMF 160, or delivery of a session management (SM) message between the UE 110 and the SMF 160. All or some of the functions of the AMF 150 may be supported in a single instance of one AMF 150.

The SMF 160 may provide session management functions. When the UE 110 has multiple sessions, the sessions may be respectively managed by different SMFs 160. For example, the SMF 160 may perform at least one function among session management (e.g., session establishment, modification, and release including maintaining a tunnel between the UPF 170 and the access network node), selection and control of the user plane (UP) function, configuration of traffic steering for the UPF 170 to route traffic to an appropriate destination, termination of the SM part of the NAS message, downlink data notification (DDN), or an initiator of AN-specific SM information (e.g., delivery to the access network through the N2 interface via the AMF 150). All or some of the functions of the SMF 160 may be supported in a single instance of one SMF 160.

The PCF 180 may perform a function for configuring and maintaining a policy rule. For example, the PCF 180 may configure a network policy rule for the user, service, or application. The policy may include a policy for network resources, such as quality of service (QOS), priority, and bandwidth allocation. The PCF 180 may transfer the policy determination to the SMF (e.g., the SMF 160) and manage user fee policies and collect fee-related information.

A network slice selection function (NSSF) 190 may perform functions related to network slicing over the 5G network. The NSSF 190 may select a network slice. For example, when the UE is connected to the network, the NSSF 190 may select a network slice most appropriate for a specific user or service. The NSSF 190 may manage network slicing information. The network slicing information may include data related to slice configuration, capacity, performance, etc. The NSSF 190 may perform functions related to mapping and allocation of network slices. For example, the NSSF 190 may map and allocate users to appropriate network slices based on user requests, service requirements, network policies, etc.

An authentication server function (AUSF) 151 may perform functions related to authentication. The AUSF 151 may perform authentication for UEs attempting to access the network. The AUSF 151 may determine whether the UE is authorized to access the network, based on the user's identity information and authentication credentials. The AUSF 151 may manage information related to the user's authentication credentials, encryption keys, authentication protocols, etc. The AUSF 151 may generate and manage security keys to secure communication between users and the network.

The UDM 153 may perform functions related to user data management. The UDM 153 may store and manage user profile data, such as user information, service subscription information, and authentication information. The UDM 153 may store user authentication information and may provide necessary information to the AUSF (e.g., AUSF 151) during the authentication process. The UDM 153 may perform the functions of managing the user's unique identity information and synchronizing and sharing user data with other network entities.

A link between network entities included in a 5G communication network may be referred to as a reference point. The reference point may also be referred to as an interface. Hereinafter, reference points (hereinafter used interchangeably with interfaces) included in the 5G system architecture related to various embodiments of the disclosure will be exemplified.
N1: the reference point between the UE 110 and the AMF 150
N2: the reference point between (R) AN 120, and AMF 150
N3: the reference point between (R) AN 120, and UPF 170
N4: the reference point between the SMF 160 and the UPF 170
N5: the reference point between the PCF 180 and the application function (AF) 145
N6: the reference point between the UPF 170 and a data network (DN) 140
N7: the reference point between the SMF 160 and the PCF 180
N8: the reference point between the UDM 153 and the AMF 150
N9: the reference point between two core UPFs 170
N10: the reference point between the UDM 153 and the SMF 160
N11: the reference point between the AMF 150 and the SMF 160
N12: the reference point between the AMF 150 and the AUSF 151
N13: the reference point between the UDM 153 and the AUSF 151
N14: the reference point between two AMFs 150
N15: the reference point between PCF 180 and AMF 150 in non-roaming scenario and reference point between PCF 180 in visited network and AMF 150 in roaming scenario
N22: the reference point between the AMF 150 and the NSSF 190

FIG. 1B illustrates a wireless environment including a core network in a wireless communication system according to an embodiment of the disclosure.

Referring to FIG. 1B, a wireless communication system may include a RAN 120 and a core network (CN) 130. What overlaps the description taken in conjunction with FIG. 1A may be omitted from the description taken in conjunction with FIG. 1B.

The RAN 120 is a network connected to a UE (e.g., UE 110) and may include an infrastructure for providing radio access to the UE. The RAN 120 may include a set of a plurality of base stations including a base station (BS) 125 (e.g., eNB, ng-eNB, or gNB), and the plurality of base stations may be connected to each other and communicate with each other through interfaces formed therebetween. At least some of the interfaces between the plurality of base stations may be wired or wireless.

The base station 125 (e.g., gNB) may have a structure divided into a central unit (CU) and a distributed unit (DU). One CU may control multiple DUs. The base station 125 may be denoted in other terms, such as an ‘access point (AP)’, a ‘next generation node B (gNB)’, a ‘5th generation (5G) node’, a ‘wireless point’, or a ‘transmission/reception point (TRP)’ or in other various terms with an equivalent technical meaning thereto.

The UE 110 may access the RAN 120 and communicate through a channel established with the base station 125.

The core network 130 may process data and control signals related to the UE 110 transmitted/received through the RAN 120. The core network 130 may perform various functions, such as control of the user plane and control plane, processing of mobility, management of subscriber information, charging, and interactions with other types of systems (e.g., long term evolution (LTE) systems). To perform the various functions described above, the core network may include a plurality of entities functionally separated entities and having different network functions (NFs). For example, the core network 130 may include an AMF 150, an SMF 160, a UPF 170, a PCF 180, a network repository function (NRF) 159, a UDM 153, a network exposure function (NEF) 155, and/or a unified data repository (UDR) 157.

The UE 110 may be connected to the RAN 120 to access the AMF 150 that performs the mobility management function of the core network 130. The AMF 150 may perform access to the RAN 120 and mobility management of the UE 110. The SMF 160 may manage sessions. The AMF 150 may connect to the SMF 160, and the AMF 150 may route session related messages for the UE 110 to the SMF 160. The SMF 160 may be connected to the UPF 170 to allocate a user plane resource to be provided to the UE 110, and may establish a tunnel for transmitting data between the base station 125 and the UPF 170. The PCF 180 may manage information related to the policy and charging for the session used by the UE 110.

The NRF 159 may store information about NFs installed in the mobile network operator network and may notify of the stored information. The NRF 159 may be connected to all NFs. When starting driving in the operator network, each NF may inform the NRF 159 that the corresponding NF is being driven in the network by registering with the NRF 159.

The UDM 153 is an NF performing a role similar to that of the home subscriber server (HSS) of the 4G network, and may store subscription information about the UE 110 or the context used by the UE 110 in the network.

The NEF 155 may serve to connect the third party server and the NF in the 5G mobile communication system. The NEF 155 may provide data to the UDR 157, or update or obtain data.

The UDR 157 may store subscription information about the UE 110, may store policy information, may store data exposed to the outside, or may store information necessary for a third party application. The UDR 157 may also serve to provide the stored data to another NF.

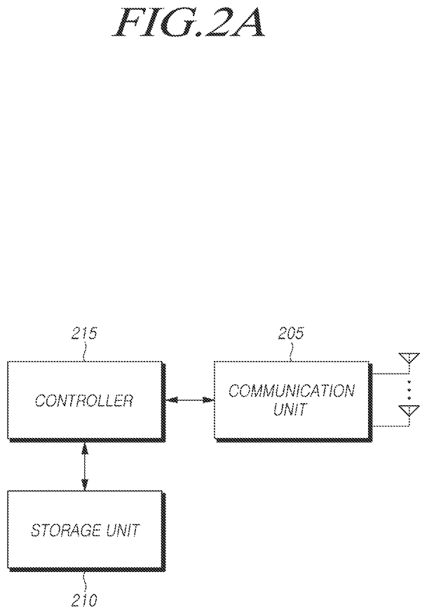

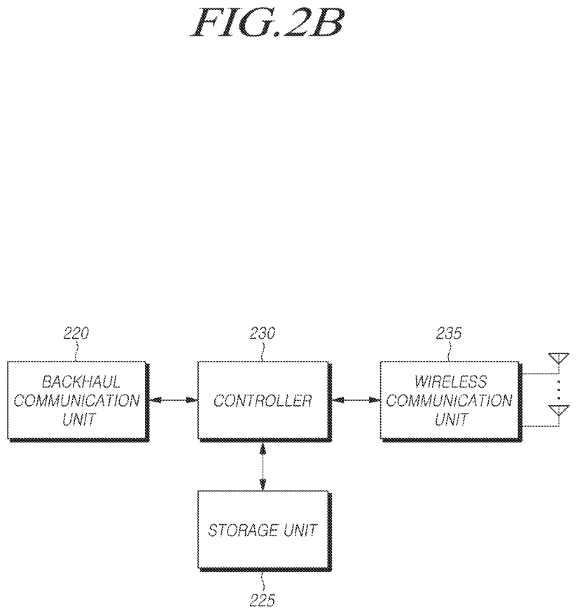

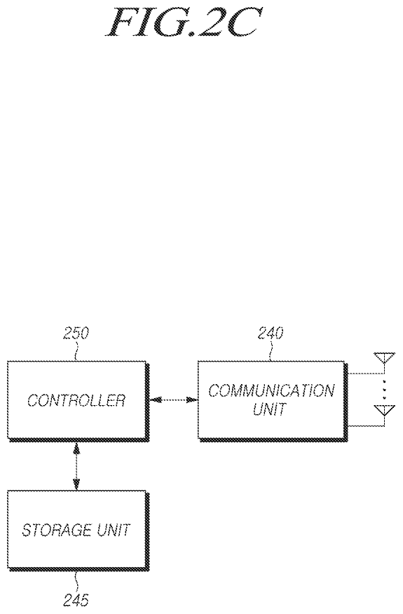

FIG. 2A illustrates an example of a functional structure of a UE according to an embodiment of the disclosure.

The configuration shown in FIG. 2A may be appreciated as the configuration of the UE 110. Further, the term “ . . . unit” and the suffix “ . . . er” as used herein denote a unit processing at least one function or operation and be implemented in hardware, software, or a combination thereof.

Referring to FIG. 2A, a UE 110 according to an embodiment of the disclosure may include a communication unit 205, a storage unit 210, and a controller 215.

The communication unit 205 may perform functions to transmit/receive signals via a wireless channel. For example, the communication unit 205 may perform the function of conversion between a baseband signal and bit stream according to the system physical layer specifications. For example, upon data transmission, the communication unit 205 may encode and modulate a transmission bit stream, thereby generating complex symbols. Also, when receiving data, the communication unit 205 may restore the received bit string by demodulating and decoding the baseband signal. Further, the communication unit 205 may up-convert the baseband signal into a radio frequency (RF) band signal, transmit the RF band signal through an antenna, and down-convert the RF band signal received through the antenna into the baseband signal. For example, the communication unit 205 may include a transmission filter, a reception filter, an amplifier, a mixer, an oscillator, a digital-to-analog converter (DAC), or an analog-to-digital converter (ADC).

The communication unit 205 may include multiple transmission/reception paths. The communication unit 205 may include at least one antenna array constituted of multiple antenna elements. The communication unit 205 may be configured of a digital circuit and an analog circuit (e.g., a radio frequency integrated circuit (RFIC)). Here, the digital circuit and analog circuit may be implemented in a single package. The communication unit 205 may include multiple RF chains. The communication unit 205 may perform beamforming.

The communication unit 205 may transmit and receive signals as described above. In the following description, the whole or part of the communication unit 205 may be referred to as a ‘transmitter,’ ‘receiver,’ or ‘transceiver.’ Further, transmission and reception performed via a wireless channel in the following description may also mean performing the above-described process by the communication unit 205.

The storage unit 210 may store a basic program for operating the UE, application programs, configuration information, or other data. The storage unit 210 may be configured as volatile memory, non-volatile memory, or a combination of volatile memory and non-volatile memory. The storage unit 210 may provide the stored data according to a request from the controller 215.

The controller 215 may control the overall operation of the UE. For example, the controller 215 may transmit and receive signals via the communication unit 205. Further, the controller 215 may record and read data in/from the storage unit 210. The controller 215 may perform the functions of the protocol stack required in the communication specifications. To that end, the controller 215 may include at least one processor or microprocessor or may include part of a processor. Part of the communication unit 205 and the controller 215 may be referred to as a communication processor (CP). According to various embodiments, the controller 215 may control to perform synchronization using the wireless communication network. For example, the controller 215 may control the UE to perform operations according to various embodiments described below.

The UE according to an embodiment of the disclosure may include a mobile equipment (ME) and a universal mobile telecommunications service (UMTS) subscriber identity module (USIM). The USIM may have, e.g., a card shape that may be inserted into and mounted through a slot included in the UE. The USIM may be, e.g., an embedded SIM (eSIM) embedded in the UE or attached to the motherboard. UE may refer to a device including all of the functions (H/W, S/W, identity information, etc.) of the UE. The ME may include the H/W portion of the mobile UE. The ME may include a mobile terminal (MT) and a terminal equipment (TE). The MT may include a part in which a function related to the radio access protocol operates, and the TE may be a part in which a control function necessary for the function related to the radio access protocol operates. The MT and TE may include a single integrated component or separate components. For example, a smartphone may be a device in which MT and TE are integrated into one. In the case of a smartphone, the TE may provide the functions of the smartphone, and the MT may provide the functions for mobile communication in the smartphone. Also, e.g., in the case of a laptop computer, the TE may include a portion for providing a function of the laptop computer itself, and the MT may include a wireless card portion for mobile communication mounted in the laptop computer. In the following description, the ME and the USIM may be expressed as separate components or integrated into the UE, and the “UE” and the “ME” may also be used interchangeably. Such a difference in expression is merely a difference according to convenience of description, and may be correctly interpreted according to the description of the UE, ME, and USIM described above.

FIG. 2B illustrates an example of a functional structure of a base station according to an embodiment of the disclosure.

The configuration shown in FIG. 2B may be appreciated as the configuration of the base station 125. Further, the term “ . . . unit” and the suffix “ . . . er” as used herein denote a unit processing at least one function or operation and be implemented in hardware, software, or a combination thereof.

Referring to FIG. 2B, a base station 125 according to an embodiment includes a wireless communication unit 235, a backhaul communication unit 220, a storage unit 225, and a controller 230.

The wireless communication unit 235 may perform functions for transmitting/receiving signals via a wireless channel. For example, the wireless communication unit 235 may perform the function of conversion between a baseband signal and bit stream according to the system physical layer specifications. For example, upon data transmission, the wireless communication unit 235 may encode and modulate a transmission bit stream, thereby generating complex symbols. Further, upon data reception, the wireless communication unit 235 may reconstruct the reception bit stream by demodulating and decoding the baseband signal.

The wireless communication unit 235 may up-convert a baseband signal into an RF band signal and then transmit the RF band signal through an antenna. The wireless communication unit 235 may down-convert the RF band signal received through the antenna into a baseband signal. To that end, the wireless communication unit 235 may include, e.g., a transmission filter, a reception filter, an amplifier, a mixer, an oscillator, a digital-to-analog converter (DAC), and an analog-to-digital converter (ADC). The wireless communication unit 235 may include multiple transmission/reception paths. Further, the wireless communication unit 235 may include at least one antenna array constituted of multiple antenna elements.

In terms of hardware, the wireless communication unit 235 may include a digital unit and an analog unit. The analog unit may be composed of a plurality of sub-units according to operating power, operating frequency, or the like. The digital unit may be implemented as at least one processor (e.g., a digital signal processor (DSP)).

The wireless communication unit 235 may transmit and receive signals as described above. Thus, the whole or part of the wireless communication unit 235 may be referred to as a ‘transmitter,’ ‘receiver,’ or ‘transceiver.’ Further, transmission and reception performed via a wireless channel in the following description may also mean performing the above-described process by the wireless communication unit 235.

The backhaul communication unit 220 may provide an interface for communicating with other nodes in the network. In other words, the backhaul communication unit 220 may convert the bit string transmitted from the base station to another node, e.g., another access node, another base station, an upper node, or a core network, into a physical signal and converts the physical signal received from another node into a bit stream.

The storage unit 225 may store a basic program for operating the base station, application programs, configuration information, or other data. The storage unit 225 may be configured as volatile memory, non-volatile memory, or a combination of volatile memory and non-volatile memory. The storage unit 225 may provide the stored data according to a request from the controller 230.

The controller 230 may control the overall operation of the base station. For example, the controller 230 may transmit and receive signals through the wireless communication unit 235 or the backhaul communication unit 220. Further, the controller 230 may record and read data in/from the storage unit 225. The controller 230 may perform the functions of the protocol stack required in the communication specifications. According to another implementation example, the protocol stack may be included in the wireless communication unit 235. To that end, the controller 230 may include at least one processor. According to various embodiments, the controller 230 may control to perform synchronization using the wireless communication network. For example, the controller 230 may control the base station to perform operations according to various embodiments described below.

FIG. 2C illustrates an example of a functional structure of an entity constituting a core network according to an embodiment of the disclosure.

The configuration illustrated in FIG. 2C may be understood as a configuration of a device having functions of at least one of network entities including the AMF 150 of FIGS. 1A and 1B. Further, the term “ . . . unit” and the suffix “ . . . er” as used herein denote a unit processing at least one function or operation and be implemented in hardware, software, or a combination thereof.

Referring to FIG. 2C, a core network entity includes a communication unit 240, a storage unit 245, and a controller 250.

The communication unit 240 may provide an interface for communicating with other devices in the network. The communication unit 240 may convert a bit string transmitted from the core network entity to another device (e.g., the base station 125 of FIG. 2B) into a physical signal. The communication unit 240 may convert the physical signal received from the other device (e.g., the base station 125 of FIG. 2B) into the bit string. The communication unit 240 may transmit and receive signals. The communication unit 240 may be referred to as a modem, a transmitter, a receiver, or a transceiver. The communication unit 240 may perform a function for allowing the core network entity to communicate with other devices or systems via the backhaul connection (e.g., the wired backhaul or the wireless backhaul) or via the network.

The storage unit 245 may store a basic program for operating the core network entity, application programs, configuration information, or other data. The storage unit 245 may be configured as volatile memory, non-volatile memory, or a combination of volatile memory and non-volatile memory. The storage unit 245 may provide the stored data according to a request from the controller 250.

The controller 250 may control the overall operation of the core network entity. For example, the controller 250 may transmit/receive signals via the communication unit 240. Further, the controller 250 may record and read data in/from the storage unit 245. The controller 250 may include at least one processor. According to an embodiment of the disclosure, the controller 250 may perform synchronization using the wireless communication network. For example, the controller 250 may control the core network entity to perform operations according to various embodiments described below.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

For convenience of description, the disclosure may use terms and names defined in 5G system (5GS) and new radio (NR) standards, which are the latest standards defined by 3GPP organizations, among currently existing communication standards. However, the disclosure is not limited by such terms and names and may be likewise applicable to wireless communication networks conforming to other standards. The disclosure may be applied to 3GPP 5G mobile communication standards (e.g., 5GS and NR) or mobile communication standards (e.g., 6G) subsequent to the 3GPP 5G mobile communication standards.

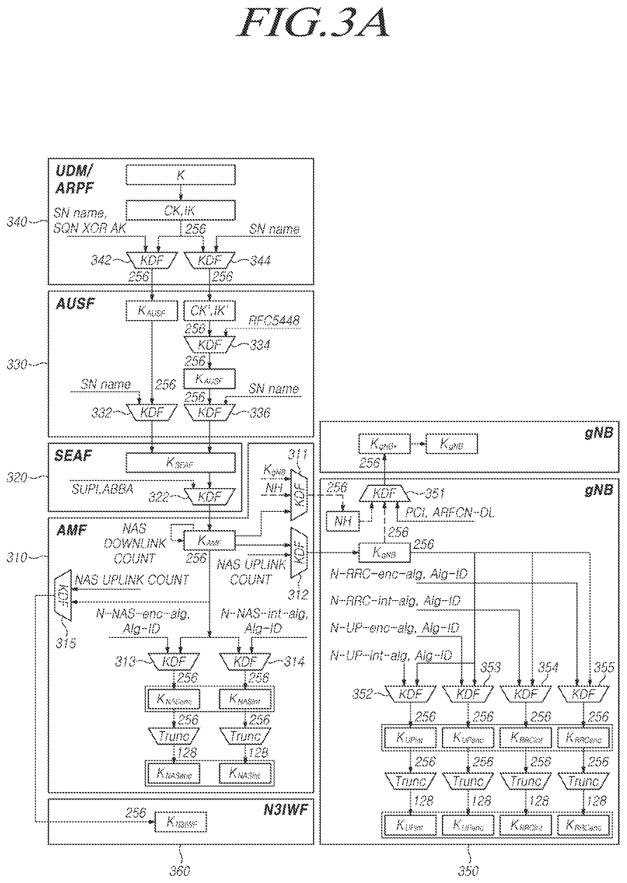

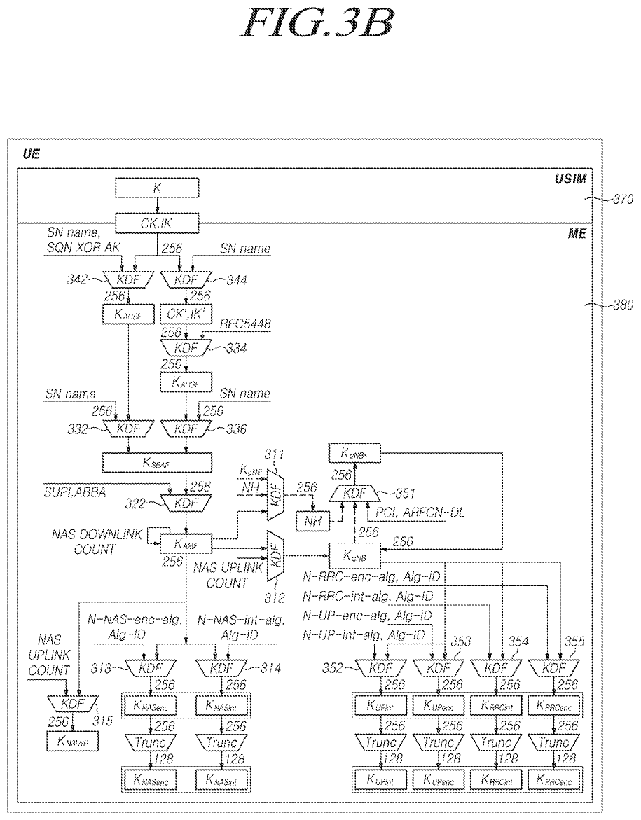

FIG. 3A illustrates an example of derivation and distribution of a key through network entities according to an embodiment of the disclosure.

FIG. 3B illustrates an example of derivation and distribution of a key through a UE according to an embodiment of the disclosure.

FIG. 3A illustrates a key hierarchy according to an authentication and key agreement (AKA) procedure of core network entities, and FIG. 3B illustrates a key hierarchy according to an authentication and key agreement procedure of a UE. What has been described in connection with FIGS. 3A and 3B, which overlaps the descriptions and definitions made above in connection with FIGS. 1A, 1B, 2A, 2B, and 2C, may be omitted. In the description of the drawings, a plurality of entities may be indicated by one reference number (e.g., UDM/ARPF/SIDF 340), but this is for convenience of description, and each of the plurality of entities may be a separate network entity.

For mutual authentication between the UE and the network entities, the UE and the network entities (e.g., security anchor function (SEAF), authentication server function (AUSF), unified data management (UDM), authentication credential repository and processing function (ARPF), and subscription identifier de-concealing function (SIDF)) each may perform authentication and key agreement procedures (AKA).

The authentication and key agreement procedure may be initiated based on a message (e.g., N1 message) transmitted by the UE to the SEAF. The UE authentication request may be transferred to the AUSF by the SEAF and finally received by the UDM/ARPF/SIDF. The SEAF is an entity present in the serving network (SN) and may serve as a medium between the UE and the home network (HN). The SEAF and the AMF may be separated or combined. The serving network may refer to a network to which the UE is wirelessly connected, and the home network may refer to a network to which the UE is registered and to be accessed. The AUSF may transmit and receive a message to and from the SEAF to authenticate the UE by the home network. The UDM/ARPF may be present in the home network and may generate an output value through an encryption algorithm based on the key K for authentication of the UE. The SIDF may decrypt (de-conceal) the subscription concealed identifier (SUCI) of the UE received from the AUSF into a subscription permanent identifier (SUPI) within the UDM/ARPF. The UDM/ARPF may select an authentication method (e.g., EAP-AKA′, 5G-AKA) based on the SUPI identified from the SIDF. According to the authentication method selected by the UDM/ARPF, the UE and the network entities may perform a mutual authentication and key agreement procedure. In this process, K_{SEAF}, which is an anchor key, may be generated. Session keys derived from K_{SEAF} may be used for non-access stratum (NAS) security configuration of UE and AMF and access stratum (AS) security configuration between UE and gNB. Hereinafter, a process of generating various keys based on K according to an authentication and key agreement procedure is described in detail with reference to the drawings.

Referring to FIG. 3A, K derivative keys (e.g., K_{SEAF}, K_{AUSF}, K_{AMF}, K_{gNB}, K_{NAS} etc.) may be generated through signaling between the network entities (e.g., AMF 310, SEAF 320, AUSF 330, UDM/ARPF/SIDF 340), the NG-RAN (e.g., gNB 350), and the N3IWF (e.g., N3IWF 360). Referring to FIG. 3B, the UE (e.g., UE 110) may generate K derivative keys (e.g., K_{SEAF}, K_{AUSF}, K_{AMF}, K_{gNB}, K_{NAS} etc.). In the following description, an AMF 310 and an SEAF 320 are described as separate entities, but depending on cases, the AMF 310 and the SEAF 320 may be integrated into one entity. The UE may include a USIM 370 and an ME 380. A ‘K’ corresponding to an authentication key may be stored in the USIM. In the description of FIG. 3B, it is described that the UE includes the USIM 370 as an example, but this is an example, and the embodiments of the disclosure may be equally applied to UEs using an eSIM.

Referring to FIG. 3A, an authentication key (hereinafter, referred to as “K”) required to authenticate subscription information of subscriber may be stored in a UDM/ARPF/SIDF 340. K may have a length of 128 bits or 256 bits. The same K as K stored in the UDM/ARPF/SIDF 340 may be stored in the USIM 370 of the UE. The UDM/ARPF/SIDF 340 or the USIM 370 may generate a session key from K using a predetermined algorithm. The session key may be, e.g., a cipher key (CK). The CK may have a length of 128 bits. The session key may be, e.g., an integrity key (IK). The IK may have a length of 128 bits. A process of generating derivative keys in the USIM 370 and the ME 380 of the UE is described in detail with reference to FIG. 3B to be described below.

According to an embodiment, the key authentication and agreement procedure (AKA) may be initiated based on an authentication request message (N1 message) transmitted by the UE to the SEAF 320. The UE authentication request may be transferred to the UDM/ARPF/SIDF 340 through an authentication request message (Nausf_UEAuthentication_Authenticate Request) transmitted from the SEAF 320 to an AUSF 330 and an authentication request message (Nudm_UEAuthentication_Get Request) transmitted from the AUSF 330 to the UDM/ARPF/SIDF 340. In this process, the SUCI of the UE included in the authentication request message (N1 message) transmitted by the UE to the SEAF 320 may be transferred to the UDM/ARPF/SIDF 340. The UDM/ARPF/SIDF 340 may select an authentication method of the UE based on the SUPI identified based on the SUCI.

In an embodiment, when the UDM/ARPF/SIDF 340 selects 5G-AKA as the authentication method, the UDM/ARPF/SIDF 340 may generate K_{AUSF} using CK and IK. In an embodiment, when the UDM/ARPF/SIDF 340 selects EAP-AKA′ as the authentication method, the UDM/ARPF/SIDF 340 may generate CK′ and IK′ using CK and IK.

The UDM/ARPF/SIDF 340 may generate K_{AUSF} or CK′ and IK′ based on key derivation functions (KDFs) 342 and 344. The UDM/ARPF/SIDF 340 may generate a K_{AUSF} having a length of 256 bits using XORed values of CK, IK, SN name, SQN and AK as input values of the KDF 342. The UDM/ARPF/SIDF 340 may generate CK′ and IK′ using the CK, IK, and SN name as input values of the KDF 344. The KDFs 342 and 344 used by the UDM/ARPF/SIDF 340 to generate K_{AUSF} or CK′ and IK′ may be HMAC-SHA-256.

The UDM/ARPF/SIDF 340 may generate an authentication vector (AV) using the generated K_{AUSF} or CK′ and IK′. After generating the authentication vector, the UDM/ARPF/SIDF 340 may transmit an authentication response message (Nudm_UEAuthentication_Get Response) to the AUSF 330. The authentication response message (Nudm_UEAuthentication_Get Response) may include the generated authentication vector.

The AUSF 330 may generate the K_{SEAF} based on the authentication response message (Nudm_UEAuthentication_Get Response) received from the UDM/ARPF/SIDF 340. The AUSF 330 may identify K_{AUSF} or CK′ and IK′ based on the authentication vector included in the authentication response message (Nudm_UEAuthentication_Get Response). For example, when the AUSF 330 identifies the K_{AUSF}, the AUSF 330 may generate the K_{SEAF} using the K_{AUSF} and SN name as input values of a KDF 332. For example, when the AUSF 330 identifies CK′ and IK′, the AUSF 330 may generate K_{AUSF} using CK′ and IK′ as input values of a KDF 334, and may generate K_{SEAF} using the generated K_{AUSF} and SN name as input values of a KDF 336. The K_{SEAF} may be used as an anchor key in a key system based on K.

The AUSF 330 may transmit an authentication response message (Nausf_UEAuthentication_Authenticate Response) to the SEAF 320. The authentication response message (Nausf_UEAuthentication_Authenticate Response) may include K_{SEAF}.

The SEAF 320 may generate the K_{AMF} using K_{SEAF}, SUPI, and anti-bidding-down between architectures (ABBA) identified from the authentication response message (Nausf_UEAuthentication_Authenticate Response) as input values of a KDF 322. The SEAF 320 may transfer the generated K_{AMF} to the AMF 310.

The AMF 310 may generate the K_{NASenc} using the K_{AMF} and the encryption algorithm identifiers (N-NAS-enc-alg and Alg-ID) as input values of a KDF 313. The encryption algorithm identifier may refer to an identifier for the encryption algorithm finally selected through NAS encryption algorithm negotiation between the AMF 310 and the UE. The generated K_{NASenc} may be used as an encryption key of NAS. K_{NASenc} may have a length of 256 bits.

The AMF 310 may generate K_{NASint} using the identifiers (N-NAS-int-alg and Alg-ID) for the K_{AMF} and the integrity protection algorithm as input values of a KDF 314. The identifier for the integrity protection algorithm may indicate the identifier of the algorithm selected by the AMF 310 through negotiation of the NAS integrity protection algorithm with the UE. The generated K_{NASint} may be used as an integrity protection key for NAS. K_{NASint} may have a length of 256 bits.

The AMF 310 may generate K_{NASenc} and K_{NASint} having a length of 128 bits, respectively, by truncating the generated K_{NASenc} and K_{NASint} having a length of 256 bits. When the security algorithm used in the NAS security configuration between the UE and the AMF 310 does not operate based on the value of 256 bits but operates based on the length of 128 bits, the AMF 310 may truncate the generated key of 256 bits into 128 bits and use the key as the NAS encryption and NAS integrity protection key.

The AMF 310 may generate a K_{gNB} using a K_{AMF} and an NAS uplink count (NAS uplink COUNT) as input values of a KDF 312. The K_{gNB} may be a key used for AS security configuration between the UE and a gNB 350. The NAS uplink count may correspond to an NAS message initiating a transition from the CM-IDLE to the CM-CONNECTED state. The AMF 310 may transfer the generated K_{gNB} to the gNB 350.

The AMF 310 may generate the K_{N3IWF} using the K_{AMF} and the NAS uplink count (NAS uplink COUNT) as input values of a KDF 315. The AMF 310 may transfer the generated K_{N3IWF} to the N3IWF 360.

The AMF 310 may generate a next hop parameter (NH) using K_{gNB}, SYNC-input, and a length of SYNC-input as input values of a KDF 311. NH may refer to a key used to provide forward security of the AMF 310. The SYNC-input used to generate the initial NH is K_{gNB}, and the SYNC-input used to generate the subsequent NH may be the previously generated NH.

The gNB 350 may generate K_{gNB*} using NH, K_{gNB}, physical cell identity (PCI), and absolute radio frequency channel number-downlink (ARFCN-DL) as input values of a KDF 351.

The gNB 350 may generate a key using the identifier of the algorithm to be used to protect the K_{gNB} and the AS as an input value of KDF 352, 353, 354, and 355. Algorithms for AS security configuration may include an algorithm for radio resource control (RRC) encryption (N-RRC-enc-alg), an algorithm for RRC integrity protection (N-RRC-int-alg), an algorithm for user plane (UP) encryption (N-UP-enc-alg), and an algorithm for UP integrity protection (N-UP-int-alg). The algorithms may be selected through negotiation between the gNB 350 and the UE.

For example, the gNB 350 may generate the K_{RRCenc} using the identifier (N-RRC-enc-alg, Alg-ID) of the algorithm for encryption of the K_{gNB} and RRC as an input value of the KDF 355. For example, the gNB 350 may generate K_{RRCint} using the identifier (N-RRC-int-alg, Alg-ID) of the algorithm for protecting integrity of the K_{gNB} and RRC as an input value of the KDF 354. For example, the gNB 350 may generate the K_{UPenc} using the identifier (N-UP-enc-alg, Alg-ID) of the algorithm for encrypting the K_{gNB} and the UP as an input value of the KDF 353. For example, the gNB 350 may generate K_{UPint} using the identifier (N-UP-int-alg, Alg-ID) of the algorithm for protecting the integrity of the K_{gNB} and the UP as an input value of the KDF 352. The generated K_{RRCenc}, K_{RRCint}, K_{UPenc}, and K_{UPint} may all have a length of 256 bits.

The gNB 350 may generate K_{RRCenc}, K_{RRCint}, K_{UPenc}, and K_{UPint} having a length of 128 bits by truncating the generated K_{RRCenc}, K_{RRCint}, K_{UPenc}, and K_{UPint} having a length of 256 bits.

Referring to FIG. 3B, a UE may generate various keys based on K stored in the USIM 370. Referring to FIG. 3A, an authentication key “K” required to authenticate subscriber subscription information may be stored in the USIM 370. K may have a length of 128 bits or 256 bits. The same K as the K stored in the UE may be stored in the UDM/ARPF/SIDF 340. In the description of FIG. 3A, various keys (e.g., CK, IK, K_{AUSF}, CK′, IK′, K_{SEAF}, K_{AMF}, K_{gNB}, K_{NASenc}, K_{NASint}, K_{RRCenc}, K_{RRCint}, K_{UPenc}, and K_{UPint}) generated based on K may also be generated in the ME 380 of the UE.

In an embodiment, when the UDM/ARPF/SIDF 340 selects the 5G-AKA as the authentication method, the ME 380 may generate the K_{AUSF} using the CK and the IK. In an embodiment, when the UDM/ARPF/SIDF 340 selects EAP-AKA′ as the authentication method, the ME 380 may generate CK′ and IK′ using CK and IK.

The ME 380 may generate K_{AUSF} or CK′ and IK′ based on key derivation functions (KDFs) 342 and 344. The ME 380 may generate K_{AUSF} using XORed values of CK, IK, SN name, SQN and AK as input values of the KDF 342. The ME 380 may generate CK′ and IK′ using the CK, IK, and SN name as input values of the KDF 344. The KDFs 342 and 344 used by the ME 380 to generate K_{AUSF} or CK′ and IK′ may be HMAC-SHA-256, and the K_{AUSF} or CK′ and IK′ generated accordingly may have a length of 256 bits.

The ME 380 may generate K_{SEAF} based on K_{AUSF} or CK′ and IK′. For example, the ME 380 may generate the K_{SEAF} using the K_{AUSF} and SN name as input values of the KDF 332. For example, the ME 380 may generate K_{AUSF} using CK′ and IK′ as input values of the KDF 334, and may generate K_{SEAF} using the generated K_{AUSF} and SN name as input values of the KDF 336. The K_{SEAF} may be used as an anchor key in a key system based on K.

The ME 380 may generate the K_{AMF} using K_{SEAF}, SUPI, and anti-bidding-down between architectures (ABBA) as input values of the KDF 322. The SEAF 320 may transfer the generated K_{AMF} to the AMF 310.

The ME 380 may generate the K_{NASenc} using the K_{AMF} and the encryption algorithm identifiers (N-NAS-enc-alg and Alg-ID) as input values of the KDF 313. The encryption algorithm identifier may refer to an identifier for the encryption algorithm finally selected through NAS encryption algorithm negotiation between the AMF 310 and the UE. The generated K_{NASenc} may be used as an encryption key of NAS and may have a length of 256 bits.

The ME 380 may generate K_{NASint} using the identifiers (N-NAS-int-alg and Alg-ID) for the K_{AMF} and the integrity protection algorithm as input values of the KDF 314. The identifier for the integrity protection algorithm may indicate the identifier of the algorithm selected by the AMF 310 through negotiation of the NAS integrity protection algorithm with the UE. The generated K_{NASint} may be used as an integrity protection key for NAS. K_{NASint} may have a length of 256 bits.

The ME 380 may generate K_{NASenc} and K_{NASint} having a length of 128 bits, respectively, by truncating the generated K_{NASenc} and K_{NASint} having a length of 256 bits. For example, when the security algorithm used in the NAS security configuration between the UE and the AMF 310 does not operate based on the value of 256 bits but operates based on the length of 128 bits, the ME 380 may truncate the generated K_{NASenc} and K_{NASint} of 256 bits into 128 bits and use the key as the NAS encryption and NAS integrity protection key.

The ME 380 may generate a K_{gNB} using a K_{AMF} and an NAS uplink count (NAS uplink COUNT) as input values of the KDF 312. The K_{gNB} may be used for AS security configuration between the UE and the gNB 350. The NAS uplink count may correspond to an NAS message initiating a transition from the CM-IDLE to the CM-CONNECTED state.

The ME 380 may generate the K_{N3IWF} using the K_{AMF} and the NAS uplink count (NAS uplink COUNT) as input values of the KDF 315.

The ME 380 may generate an NH using K_{gNB}, SYNC-input, and a length of SYNC-input as input values of the KDF 311. NH may be used to provide forward security of the AMF 310. The SYNC-input used to generate the initial NH is K_{gNB}, and the SYNC-input used to generate the subsequent NH may be the previously generated NH.

The ME 380 may generate K_{gNB*} using NH, K_{gNB}, physical cell identity (PCI), and absolute radio frequency channel number-downlink (ARFCN-DL) as input values of the KDF 351.

The ME 380 may generate a key using the identifier of the algorithm to be used to protect the K_{gNB} and the AS as an input value of the KDF 352, 353, 354, and 355. Algorithms for AS security configuration may include an algorithm for RRC encryption (N-RRC-enc-alg), an algorithm for RRC integrity protection (N-RRC-int-alg), an algorithm for user plane (UP) encryption (N-UP-enc-alg), and an algorithm for UP integrity protection (N-UP-int-alg). The algorithms may be selected through negotiation between the gNB 350 and the UE.

For example, the ME 380 may generate the K_{RRCenc} using the identifier (N-RRC-enc-alg, Alg-ID) of the algorithm for encryption of the K_{gNB} and RRC as an input value of the KDF 355. For example, the ME 380 may generate K_{RRCint} using the identifier (N-RRC-int-alg, Alg-ID) of the algorithm for protecting integrity of the K_{gNB} and RRC as an input value of the KDF 354. For example, the ME 380 may generate the K_{UPenc} using the identifier (N-UP-enc-alg, Alg-ID) of the algorithm for encrypting the K_{gNB} and the UP as an input value of the KDF 353. For example, the ME 380 may generate K_{UPint} using the identifier (N-UP-int-alg, Alg-ID) of the algorithm for protecting the integrity of the K_{gNB} and the UP as an input value of the KDF 352. The generated K_{RRCenc}, K_{RRCint}, K_{UPenc}, and K_{UPint} may all have a length of 256 bits.

The ME 380 may generate K_{RRCenc}, K_{RRCint}, K_{UPenc}, and K_{UPint} having a length of 128 bits by truncating the generated K_{RRCenc}, K_{RRCint}, K_{UPenc}, and K_{UPint} having a length of 256 bits.

Referring to FIGS. 3A and 3B, a network entity and a gNB may generate various keys based on K, and a UE 110 may also generate various keys based on K. In this regard, the keys (e.g., K_{NASenc} and K_{NASint}) used for the security configuration between the UE and the AMF and the keys (K_{RRCenc}, K_{RRCint}, K_{UPenc}, K_{UPint}) used for the security configuration between the UE and the gNB may be all generated based on KAME which is generated based on K_{SEAF} which is the anchor key and the identifier of the security algorithm (e.g., NAS encryption algorithm (NAS-enc-alg), NAS integrity protection algorithm (NAS-int-alg), RRC encryption algorithm (RRC-enc-alg), RRC integrity protection algorithm (RRC-int-alg), UP encryption algorithm (UP-enc-alg), and UP integrity protection algorithm (UP-int-alg)). This security algorithm may be selected according to negotiation between the UE and the AMF and negotiation between the UE and the gNB. The security algorithm may include a 128 bit-based algorithm and a 256 bit-based algorithm.

As described above, K_{AMF} and K_{gNB} may be generated based on K, and the AMF 310 and the gNB 350 may perform security configuration using the generated K_{AMF} and K_{gNB} as input values to the algorithm for security configuration.

To that end, the AMF 310 and the gNB 350 may select a security algorithm to be used for security configuration with the UE from among security algorithms included in the security algorithm list allocated from the network. Depending on the number of bits of K used, a 128 bit-based algorithm or a 256 bit-based algorithm may be used for NAS and AS security configuration.

Since the 256 bit-based algorithm provides a higher security level than the 128 bit-based algorithm, it is possible to provide more enhanced security. However, in order to use the 256 bit-based algorithm, not only the AMF 310 and the gNB 350, but also the UE 110 should support the 256 bit-based algorithm. Further, even if the UE supports a 256 bit-based algorithm, when the length of K is 128 bits, using the 256 bit-based algorithm merely increases the computation load but may not affect the security level.

Accordingly, the security capability of the UE and the length of K need to be provided to the AMF and the gNB in the primary authentication process so that the UE not only supports the 256 bit security algorithm but also selects the 256 bit-based algorithm only when K has a length of 256 bits.

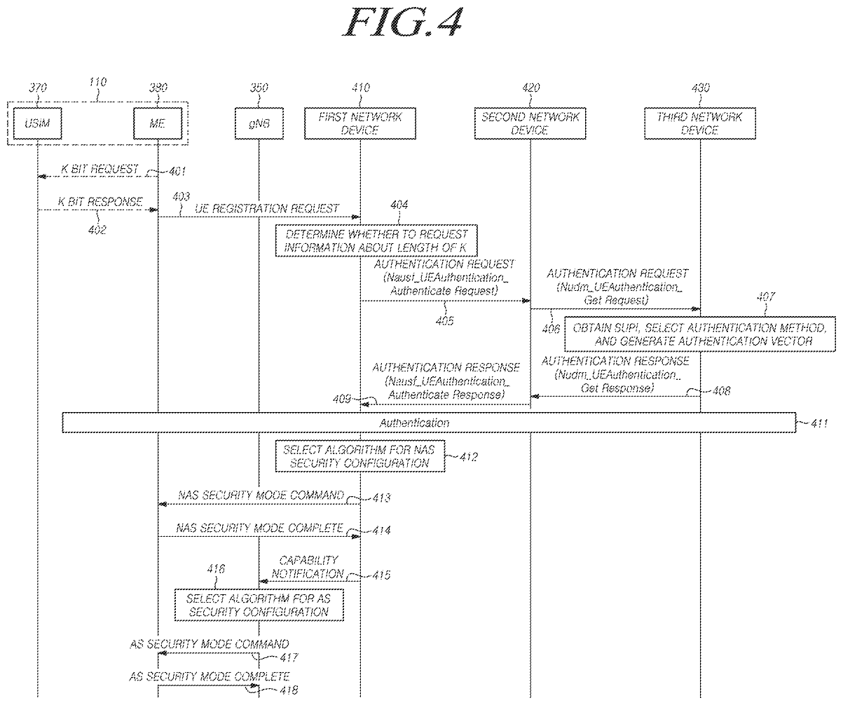

FIG. 4 illustrates a signaling flow for authentication and security configuration between a UE and network entities in a wireless communication network, according to an embodiment of the disclosure.

In the description of FIG. 4, the description overlapping the description of FIGS. 1A, 1B, 2A, 2B, 2C, 3A, and 3B may be omitted. In the description of FIG. 4, a plurality of entities may be indicated by one reference number. For example, a first network device 410 may be a device corresponding to the AMF 310 and the SEAF 320. A second network device 420 may mean a device corresponding to the AUSF 330. A third network device 430 may mean a device corresponding to the UDM/ARPF/SIDF 340. As described above, a plurality of entities may be indicated by one reference number, but this is for convenience of description, and it may be understood that each network device includes separate functions. Further, in the following description, the USIM 370 and the ME 380 are illustrated as separate components from the UE 110, but may be understood as a concept included in the UE 110. Further, in the following description, the USIM is described as an example, but this is an example, and embodiments of the disclosure may be equally applied to an eSIM.

Referring to FIG. 4, in operations 401 and 402, a UE 110 may obtain information about the length (e.g., 128 bits or 256 bits) of K stored in the USIM 370. For example, in operation 401, an ME 380 of the UE 110 may transmit a K-bit request for requesting information about the length of K (e.g., 128 bits or 256 bits) to the USIM 370. Hereinafter, in the description, K is 128 bits or 256 bits as an example, but this is merely an example, and the contents according to the disclosure may be applied even when K has a different length (e.g., 192 bits). In operation 402, in response to receiving the K-bit request, the USIM 370 may transmit a K-bit response including information about the length of K to the ME 380.

Information about the length of K may be expressed as n (e.g., 1, 2, 3) bits. For example, the information about the length of K may have a value of “0” when the length of K is 128 bits, and may have a value of “1” when the length of K is 256 bits. For example, when there is K having a length (e.g., 192 bits) other than 128 bits and 256 bits, the information about the length of K may have a value of “00” for 128 bits, “01” for 192 bits, and “10” for 256 bits using two bits. The above-described values such as “0”, “1”, “00”, “01”, and “10” are all examples, and the information about the length of K may be expressed through various methods capable of indicating the length of K as well as n bits.

The process in which the ME 380 transmits a K-bit request to the USIM 370 and receives a K-bit response in response thereto may or may not be performed depending on whether the UE 110 may provide an interface for exchanging information about the length of K between the ME 380 and the USIM 370. If the UE 110 does not identify the length of K through operations 401 and 402, the first network device 410 and the gNB 350 need to obtain information about the length of K of the UE 110 from the UDM, not the UE 110.

According to an embodiment, in operation 403, the UE 110 may transmit a registration request message to the first network device 410. The registration request message may mean a message corresponding to the N1 message transmitted by the UE 110 to the SEAF in the initial authentication and key agreement procedure.

The registration request message may include UE identification information about the UE 110, UE security capability information about the UE 110, and information indicating whether the length of K is identified (K bit get indication, hereinafter referred to as “K bit identification indicator”).

The UE identification information may include a subscription concealed identifier (SUCI) or a globally unique temporary identifier (5G-GUTI).

The UE security capability information may include information about at least one security algorithm that the UE selects to transmit to the SEAF from among security algorithms that the UE may use for NAS and AS security. For example, when the security algorithm available to the UE 110 is a 128 bit-based algorithm and a 256 bit-based algorithm, the UE 110 may select only one of the 128 bit-based algorithm and the 256 bit-based algorithm and include the selected algorithm in the UE security capability information, or may select both algorithms and include the selected algorithms in the security capability information. An operation of selecting at least one security algorithm by the UE 110 is described in detail in the following paragraphs.

The K-bit identification indicator may refer to an indicator indicating whether the UE 110 and/or the ME 380 identify (e.g., operation 402) the length of K stored in the USIM 370. For example, the K-bit identification indicator may have a value of 1 when the UE 110 identifies the length of K and a value of 0 when the UE 110 does not identify the length of K. For example, the K-bit identification indicator may have a value of 0 when the ME 380 identifies the length of K, and a value of 1 when the ME 380 does not identify the length of K.

For example, in the following description, it is described that whether the UE 110 identifies the length of K is indicated based on the value indicated by the K-bit identification indicator, but this is merely an example, and when the UE 110 does not transmit the K-bit identification indicator to the first network device, the first network device 410 may identify that the UE does not identify the length of K. For example, the ME 380 may set the K-bit identification indicator based on whether information about the length of K is provided from the USIM 370.

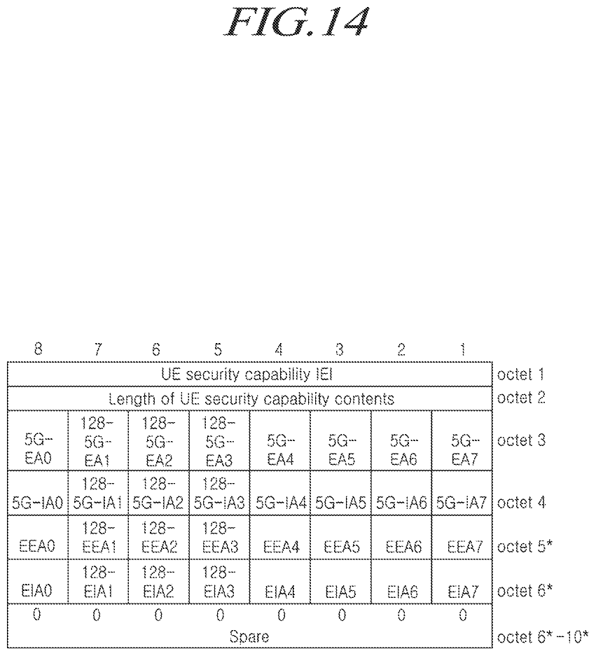

Meanwhile, according to an embodiment, in order to indicate whether the UE 110 identifies the length of K, the UE 110 may not use a separate indicator such as the K-bit identification indicator described above. In other words, the UE 110 may inform the first network device 410 of whether the UE 110 identifies the length of K in another manner without using a separate K-bit identification indicator. In an embodiment, the UE 110 may inform the first network device 410 of whether the UE 110 identifies the length of K using a part not used in the UE security capability information (e.g., some fields not used in the UE security capability information of FIG. 14). The UE security capability information may be used by the UE and the network device to indicate which security algorithm(s) are supported by the UE for NAS security and AS security. The UE security capability information may have, e.g., a data format/structure such as the UE security capability information of FIG. 14. Hereinafter, an example of security capability information is described with reference to FIG. 14.

FIG. 14 illustrates an example of UE security capability information according to an embodiment of the disclosure.

Referring to FIG. 14, UE security capability information may have a minimum length of 4 octets and a maximum length of 10 octets. Octets 5 to 10 may be optional. For example, when the UE supports any security algorithm (e.g., EPS encryption algorithm and EPS integrity protection algorithm) for AS security through E-UTRA connected to the 5G CN, the UE security capability information may include octet 5 and 6. Octet 1 of the UE security capability information may include a field (UE security capability IEI) indicating the identifier of the UE security capability information. Octet 2 of the UE security capability information may include a field (the length of UE security capability contents) indicating the length of the UE security capability information. Information about the 5G security algorithm (e.g., the 5G encryption algorithm and/or the 5G integrity protection algorithm) may be provided using octet 3 and octet 4 of UE security capability information. Octet 3 of the UE security capability information may include fields indicating whether a corresponding 5G encryption algorithm is supported. For example, bit 8 of octet 3 of the UE security capability information may correspond to the field indicating whether the 5GS encryption algorithm 5G-EA0 is supported, bits 7, 6, and 5 of octet 3 of the UE security capability information, respectively, may correspond to the field (128-5G-EA1 field) indicating whether the 5GS encryption algorithm 128-5G-EA1 (e.g., the 128 bit-based 5G encryption algorithm EA1) is supported, the field (128-5G-EA2 field) indicating whether the 5GS encryption algorithm 128-5G-EA2 (e.g., the 128 bit-based 5G encryption algorithm EA2) is supported, and the field (128-5G-EA3 field) indicating whether the 5GS encryption algorithm 128-5G-EA3 (e.g., the 128 bit-based 5G encryption algorithm EA3) is supported.

In an embodiment, at least one of the fields included in octet 3 of the UE security capability information may be a field indicating whether a 256 bit-based 5G encryption algorithm is supported. For example, the 5G-EA4 field, the 5G-EA5 field, and the 5G-EA6 field respectively corresponding to bits 4, 3, and 2 of octet 3 of UE security capability information may be used to indicate whether 256 bit-based encryption algorithm 5G-EA4, encryption algorithm 5G-EA5, and encryption algorithm 5G-EA6, respectively, are supported.

In an embodiment of the disclosure, when the corresponding 5G encryption algorithm is supported by the UE, the value of the field corresponding to the corresponding 5G encryption algorithm may be set to a first value (e.g., 1), and when the corresponding 5G encryption algorithm is not supported by the UE, the value of the field corresponding to the corresponding 5GS encryption algorithm may be set to a second value (e.g., a first value (e.g., 0). For example, when the 5GS encryption algorithm 5G-EA0 is supported by the UE, bit 8 (or the field corresponding to bit 8) of octet 3 of the UE security capability information may be set to 1, and when the 5GS encryption algorithm 5G-EA0 is not supported by the UE, bit 8 (or the field corresponding to bit 8) of octet 3 of the UE security capability information may be set to 0. For example, when the 128 bit 5GS encryption algorithm 128-5G-EA1 is supported by the UE, bit 7 (or the field corresponding to bit 7) of octet 3 of the UE security capability information may be set to 1, and when the 5GS encryption algorithm 128-5G-EA1 is not supported by the UE, bit 7 (or the field corresponding to bit 7) of octet 3 of the UE security capability information may be set to 0. For example, when the 256 bit 5GS encryption algorithm 5G-EA4 is supported by the UE, bit 4 (or the field corresponding to bit 4) of octet 3 of the UE security capability information may be set to 1, and when the 5GS encryption algorithm 5G-EA4 is not supported by the UE, bit 4 (or the field corresponding to bit 4) of octet 3 of the UE security capability information may be set to 0. Octet 4 of the UE security capability information may include fields indicating whether a corresponding 5G integrity protection algorithm is supported. For example, bit 8 of octet 4 of the UE security capability information may correspond to the field indicating whether the 5GS integrity protection algorithm 5G-IA0 is supported, bits 7, 6, and 5 of octet 4 of the UE security capability information, respectively, may correspond to the field (128-5G-IA1 field) indicating whether the 5GS integrity protection algorithm 128-5G-IA1 (e.g., the 128 bit-based 5G integrity protection algorithm IA1) is supported, the field (128-5G-IA2 field) indicating whether the 5GS integrity protection algorithm 128-5G-IA2 (e.g., the 128 bit-based 5G integrity protection algorithm IA2) is supported, and the field (128-5G-IA3 field) indicating whether the 5GS integrity protection algorithm 128-5G-IA3 (e.g., the 128 bit-based 5G integrity protection algorithm IA3) is supported.

In an embodiment, at least one of the fields included in octet 4 of the UE security capability information may be a field indicating whether a 256 bit-based 5G integrity protection algorithm is supported. For example, the 5G-IA4 field, the 5G-IA5 field, and the 5G-IA6 field respectively corresponding to bits 4, 3, and 2 of octet 4 of UE security capability information may be used to indicate whether 256 bit-based encryption algorithm 5G-IA4, encryption algorithm 5G-IA5, and encryption algorithm 5G-IA6, respectively, are supported.

In an embodiment, when the corresponding 5G integrity protection algorithm is supported by the UE, the value of the field corresponding to the corresponding 5G integrity protection algorithm may be set to a first value (e.g., 1,) and when the corresponding 5G integrity protection algorithm is not supported by the UE, the value of the field corresponding to the corresponding 5GS integrity protection algorithm may be set to a second value (e.g., 0). For example, when the 5GS integrity protection algorithm 5G-IA0 is supported by the UE, bit 8 (or the field corresponding to bit 8) of octet 4 of the UE security capability information may be set to 1, and when the 5GS integrity protection algorithm 5G-IA0 is not supported by the UE, bit 8 (or the field corresponding to bit 8) of octet 4 of the UE security capability information may be set to 0. For example, when the 128 bit 5GS integrity protection algorithm 128-5G-IA1 is supported by the UE, bit 7 (or the field corresponding to bit 7) of octet 4 of the UE security capability information may be set to 1, and when the 5GS integrity protection algorithm 128-5G-IA1 is not supported by the UE, bit 7 (or the field corresponding to bit 7) of octet 4 of the UE security capability information may be set to 0. For example, when the 256 bit 5GS integrity protection algorithm 128-5G-IA4 is supported by the UE, bit 4 (or the field corresponding to bit 4) of octet 4 of the UE security capability information may be set to 1, and when the 5GS integrity protection algorithm 128-5G-IA4 is not supported by the UE, bit 4 (or the field corresponding to bit 4) of octet 4 of the UE security capability information may be set to 0.

In an embodiment, the 256 bit 5G encryption algorithm or the integrity protection algorithm may use at least one of octet 7 to octet 10.

Meanwhile, at least one field in the UE security capability information may not be used. ‘Not used’ here may mean, e.g., that it is not used for the purpose of indicating whether the algorithm is supported. For example, the number of fields used in octet 3 of UE security capability information may be less than 8. For example, when there are seven available 5G encryption algorithms, seven (e.g., the 5G-EA0 field to the 5G-EA6 field of FIG. 14) of the eight fields included in octet 3 of the UE security capability information may be used to indicate whether the corresponding encryption algorithm is supported by the UE. In this case, one field (e.g., the 5G-EA7 field of FIG. 14) among the eight fields included in octet 3 of the UE security capability information may not be used to indicate whether the corresponding encryption algorithm is supported by the UE. For example, the number of fields used in octet 4 of UE security capability information may be less than 8. For example, when there are seven available 5G integrity protection algorithms, seven (e.g., the 5G-IA0 field to the 5G-IA6 field of FIG. 14) of the eight fields included in octet 4 of the UE security capability information may be used to indicate whether the corresponding integrity protection algorithm is supported by the UE. In this case, one field (e.g., the 5G-IA7 field of FIG. 14) among the eight fields included in octet 4 of the UE security capability information may not be used to indicate whether the corresponding integrity protection algorithm is supported by the UE. For example, some of octet 5 to 10 of UE security capability information may not be used. For example, at least one of the EEA7 field of octet 5, the 5G-EIA7 field of octet 6, and the empty fields of octet 7 to 10 of the UE security capability information may not be used.

A portion (or field) not used in the UE security capability information (e.g., at least one of the 5G-EA7 field of octet 3, the 5G-IA7 field of octet 4, the EEA7 field of octet 5, the 5G-EIA7 field of octet 6, and the empty fields of octet 7 to 10, or other values of the UE security capability information of FIG. 14) may be used to indicate whether the UE 110 identifies the length of K. For example, if the UE 110 receives information (e.g., K-bit information) about the length of K from the USIM 370 (i.e., if the UE 110 identifies the length of K), the UE 110 may use a portion not used in the UE security capability information (e.g., at least one of the 5G-EA7/5G-IA7 field of octet 3/octet 4 of the UE security capability information, the EEA7/EIA7 field of octet 5/octet 6, or the empty fields of octet 7-10, or other values). For example, when K is 256 bits, the UE 110 may set at least one of the portions (or fields) not used in the UE security capability information to 1 and transmit the set value to the first network device 410. In this case, it is possible to indicate to the first network device 410 whether the UE 110 identifies the length of K only by transmitting the UE security capability information, without transmitting a separate indicator such as the K-bit identification indicator described above.

The UE 110 may select at least one of security algorithms available to the UE 110 based on whether the information about the length of K is identified.

In an embodiment, when the UE 110 does not identify the information about the length of K, the UE 110 may select all security algorithms available to the UE 110.

In an embodiment, when the UE 110 identifies the information about the length of K, the UE 110 may select the security algorithm corresponding to the identified length of K from among available security algorithms. For example, the UE 110 may select a security algorithm based on bits less than or equal to the length of K. For example, when the security algorithm available to the UE 110 is a 128 bit-based security algorithm and a 256 bit-based security algorithm, and K is 128 bits, the UE 110 may select a 128 bit-based algorithm, but may not select a 256 bit-based algorithm. For example, when the security algorithm available to the UE 110 is a 128 bit-based security algorithm and a 256 bit-based security algorithm, and K is 256 bits, the UE 110 may select both the 128 bit-based algorithm and the 256 bit-based algorithm. For example, when the security algorithm available to the UE 110 is a 128 bit-based security algorithm and K is 128 bits, the UE 110 may select only the 128 bit-based algorithm. For example, when the security algorithm available to the UE 110 is a 128 bit-based security algorithm and K is 256 bits, the UE 110 may select only the 128 bit-based algorithm. As described above, information about the selected at least one security algorithm (e.g., the set of identifiers of the selected at least one security algorithm) may be included in the registration request message transmitted by the UE 110 to the first network device 410.

Although FIG. 4 illustrates that the UE 110 directly transmits a registration request message to the first network device 410, the UE 110 may transmit the registration request message to the first network device 410 through the gNB 350. For example, the gNB 350 may transparently forward the registration request message received from the UE 110 to the first network device 410.

According to an embodiment, in operation 404, the first network device 410 may determine whether to request information about the length of K.

The first network device 410 may determine whether to request information about the length of K, based on UE security capability information (e.g., UE security capability information of FIG. 14) included in the registration request message and/or information indicating whether the length of K is identified (e.g., a K-bit identification indicator or some fields not used in the UE security capability information of FIG. 14).

The first network device 410 may determine whether to request the information about the length of K, based on whether the information about the security algorithm, which is based on a value larger than the first value (e.g., 128 bits) among the security algorithms included in the UE security capability information, is included. In the following description, the first value is 128 bits as an example, but this is merely an example, and the first value may have another value.

In an embodiment, when only the security algorithm based on the first value (e.g., 128 bits) is included in the security capability information about the UE, the first network device 410 may determine not to request the information about the length of K.

In an embodiment, when the security capability information about the UE includes a security algorithm based on a first value (e.g., 128 bits) and a security algorithm based on a second value (e.g., 256 bits) larger than the first value, the first network device 410 may identify whether information about the length of K is obtained through a K-bit identification indicator. For example, when it is identified that the length of K is obtained through the K-bit identification indicator, the first network device 410 may determine not to request information about the length of K. For example, when it is identified that the length of K is not obtained through the K-bit identification indicator, the first network device 410 may determine to request information about the length of K. It is described that whether the UE 110 identifies the length of K is indicated based on the value indicated by the K-bit identification indicator, but this is merely an example, and when the UE 110 does not transmit the K-bit identification indicator to the first network device 410, the first network device 410 may identify that the UE does not identify the length of K.

According to an embodiment, in operation 405, the first network device 410 may transmit a UE authentication request (Nausf_UEAuthentication_Authenticate Request) message to the second network device 420.

The UE authentication request message may include UE identification information (e.g., SUCI or SUPI) and/or information about the serving network (e.g., SN name).

The UE authentication request message may or may not include a K-bit request. When the first network device 410 determines to request information about the length of K, the UE authentication request message may include a K-bit request. When the first network device 410 determines not to request information about the length of K, the UE authentication request message may not include a K-bit request.

When the first network device 410 determines to request information about the length of K to the second network device 420, the authentication request message may include a “K-bit request indicator” for requesting information about the length of K. When the first network device 410 determines not to request information about the length of K to the second network device 420, the authentication request message may not include a K-bit request indicator for requesting information about the length of K. For example, when the first network device 410 identifies the length of K through the registration request message received from the UE 110 or, although failing to identify the length of K, receives that the UE does not support the 256 bit-based security algorithm, the first network device 410 may not include the K-bit request indicator in the authentication request message transmitted to the second network device 420.

According to an embodiment, in operation 406, the second network device 420 may transmit an authentication request (Nudm_UEAuthentication_Get Request) message to the third network device 430. The authentication request message may include UE identification information (e.g., SUCI or SUPI) and/or information about the serving network (e.g., SN name).

When the authentication request message received by the second network device 420 from the first network device 410 includes a K-bit request indicator, the authentication request message transmitted by the second network device 420 to the third network device 430 may include a K-bit request indicator for requesting information about the length of K.

When the authentication request message received by the second network device 420 from the first network device 410 does not include the K-bit request indicator, the authentication request message transmitted by the second network device 420 to the third network device 430 may not include the K-bit request indicator for requesting information about the length of K.

According to an embodiment, in operation 407, the third network device 430 may obtain the SUPI through the authentication request message received from the second network device 420, may select an authentication method (e.g., EAP-AKA′ or 5G-AKA), and may generate an authentication vector.

The third network device 430 may de-conceal the SUCI to identify the SUPI.

The third network device 430 may select an authentication method based on the SUPI.

The third network device 430 may generate an authentication vector according to the selected authentication method.

The third network device 430 may generate a key (e.g., K_{AUSF} in case of 5G-AKA, or CK′ and IK′ in case of EAP-AKA′) based on K. The third network device 430 may transfer the generated key to the second network device 420 through the authentication vector. K may mean the same K as K of the USIM 370 of the UE 110.

According to an embodiment, in operation 408, the third network device 430 may transmit an authentication response (Nudm_Authentication_Get Response) message to the second network device 420.

The third network device 430 may transmit the authentication response message to the second network device 420 based on whether the K-bit request indicator is included in the authentication request message received from the second network device 420.

In an embodiment, when the K-bit request indicator is included in the authentication request message received by the third network device 430 from the second network device 420, the authentication response message may include information about the length of K. For example, the information about the length of K may be a value (e.g., 128 bits or 256 bits) clearly indicating the bits of K, or a separate indicator (in this example, it may be indicated that K is 128 bits in such a manner that e.g., when a K-bit request is received, a separate indicator is transmitted if K is 256 bits, and no separate indicator is transmitted if K is 128 bits) may be transmitted. Or, when K is 256 bits, the RAND value generated by the third network device 430 is generated in 256 bits, and it is transmitted to the second network device 420 or, when K is 128 bits, the RAND value generated by the third network device 430 is generated in 128 bits, and it may be transmitted to the second network device 420. Even when the RAND value generated by the third network device 430 is 256 bits, the RAND value actually used by the third network device 430 to generate an authentication-related vector may be 128 bits. In that case, the generated 256 bit RAND value may be truncate into 128 bits and used.

In an embodiment, when the K-bit request indicator is not included in the authentication request message received from the second network device 420, the third network device 430 may not include the information about the length of K in the authentication response message.

According to an embodiment, in operation 409, the second network device 420 may transmit an authentication response message (Nausf_UEAuthentication_Authenticate Response) to the first network device 410.

The second network device 420 may transmit the authentication response message to the first network device 410 based on whether the authentication response message received from the third network device 430 includes information about the length of K.

In an embodiment, when the authentication response message received by the second network device 420 from the third network device 430 includes information about the length of K, the authentication response message transmitted to the first network device 410 may include information about the length of K.

In an embodiment, when the authentication response message received by the second network device 420 from the third network device 430 does not include the information about the length of K, the authentication response message transmitted to the first network device 410 may not include the information about the length of K.

According to an embodiment, in operation 411, the UE 110 and network entities may perform an authentication procedure.

Although not shown in the drawings, the authentication procedure according to operation 411 may include an operation in which the first network device 410 transmits an authentication request to the UE 110, an operation in which the UE 110 accordingly generates an authentication response (e.g., RES*) and transmits the authentication response to the first network device 410, an operation in which the first network device 410 generates HRES* based on the authentication response received from the UE 110 and compares HRES* with HXRES*, an operation in which the first network device 410 transmits a UE authentication request to the second network device 420 based on the comparison result, an operation in which the second network device 420 verifies RES*, and an operation in which the second network device 420 transmits an authentication response to the first network device 410 based on the identification result. The authentication response transmitted by the second network device 420 to the first network device 410 may include K_{SEAF}. The first network device 410 may generate a K_{AMF} based on the received K_{SEAF}. Even if the ME 380 (or the UE 110) receives the 256 bit RAND value from the first network device 410 through the gNB 350, the ME 380 may truncate the received RAND value into 128 bits and transfer the same to the USIM 370. Alternatively, even if the USIM 370 receives the 256 bit RAND value, it may be truncated into 128 bits and used for an authentication process.

Although not shown in the drawings, if the first network device 410 receives information about K, as the RAND value, from the third network device 430, the gNB 350 may infer information about K through the RAND value. For example, when the length of the RAND value is 256 bits, the gNB 350 may identify that the length of K is 256 bits, or may identify that 256 bit-based algorithm may be used with the corresponding UE.

According to an embodiment, in operation 412, the first network device 410 may select an algorithm (hereinafter, referred to as a “NAS security algorithm”) for security configuration with the UE 110.

When it is identified that the authentication procedure of the UE 110 is successful in operation 411, the first network device 410 may select the NAS security algorithm. The NAS security algorithm may include an NAS encryption algorithm and an NAS integrity protection algorithm.

The first network device 410 may select the NAS security algorithm based on at least one of information about the length of K identified based on the message received from the UE 110 or the third network device 430, information about the priority of the NAS security algorithm of the first network device 410, or UE security capability information obtained from the UE 110 or the third network device 430. The information about the NAS security algorithm priority of the first network device 410 may include information about a list of algorithms supportable by the first network device 410. For example, the information about the NAS security algorithm priority may indicate information about the priority (e.g., an order) between the plurality of algorithms included in the list.

In an embodiment, the first network device 410 may select the NAS security algorithm based on the information about the length of K identified based on the message (e.g., the registration request message of operation 403 or the authentication response message of operation 409) received from the third network device 430 through the UE 110 or the second network device 420. For example, when the length of K is 128 bits, the first network device 410 may select a 128 bit-based algorithm. For example, when the length of K is 256 bits, the first network device 410 may select a 128 bit-based algorithm or a 256 bit-based algorithm.

In an embodiment, the first network device 410 may select the NAS encryption algorithm and the NAS integrity protection algorithm as the same or different algorithms. For example, both the NAS encryption algorithm and the NAS integrity protection algorithm may be selected as 256 bit-based algorithms. For example, both the NAS encryption algorithm and the NAS integrity protection algorithm may be selected as 128 bit-based algorithms. For example, the NAS encryption algorithm may be selected as a 128 bit-based algorithm and may be selected as a 256 bit-based algorithm for the NAS integrity protection algorithm. For example, the NAS encryption algorithm may be selected as a 256 bit-based algorithm and may be selected as a 128 bit-based algorithm for the NAS integrity protection algorithm.

In an embodiment, the first network device 410 may select the NAS security algorithm based on the information about the length of K and the information about the algorithm priority. For example, when it is identified that the length of K is 128 bits and the 128 bit-based algorithm has a higher priority than the 256 bit-based algorithm in the information about the algorithm priority, the first network device 410 may select the 128 bit-based algorithm. For example, when it is identified that the length of K is 128 bits and the 256 bit-based algorithm has a higher priority than the 128 bit-based algorithm in the information about the algorithm priority, the first network device 410 may select the 128 bit-based algorithm. For example, when it is identified that the length of K is 256 bits and the 256 bit-based algorithm has a higher priority than the 128 bit-based algorithm in the information about the algorithm priority, the first network device 410 may select the 256 bit-based algorithm. For example, when it is identified that the length of K is 256 bits and the 128 bit-based algorithm has a higher priority than the 256 bit-based algorithm in the information about the algorithm priority, the first network device 410 may select the 128 bit-based algorithm. In this case, because a 128 bit-based algorithm needs to be used, the first network device 410 may truncate to 128 bits when keys (e.g., K_{NASenc}, K_{NASint}, etc.) generated as described below have a length of 256 bits. However, even if K has a length of 256 bits among the above-described examples, when the only algorithm included in the security capability information about the UE is a 128 bit-based algorithm, the first network device 410 may select the 128 bit-based algorithm.

In an embodiment of the disclosure, the first network device 410 may select the NAS security algorithm based on the information about the length of K and/or the information about the security capability of the UE. For example, when the length of K is 128 bits and the UE supports only the 128 bit-based algorithm, the first network device 410 may select the 128 bit-based algorithm. For example, when the length of K is 128 bits and the UE supports the 128 bit-based algorithm and the 256 bit-based algorithm, the first network device 410 may select the 128 bit-based algorithm. Further, e.g., when the length of K is 256 bits and the UE supports the 128 bit-based algorithm and the 256 bit-based algorithm, the first network device 410 may select the 128 bit-based algorithm or the 256 bit-based algorithm. In this case, the first network device 410 may select the 128 bit-based algorithm or the 256 bit-based algorithm based on the information about the security algorithm priority of the first network device 410. When the 256 bit-based algorithm has a higher priority than the 128 bit-based algorithm, the first network device 410 may select the 256 bit-based algorithm. When the 128 bit-based algorithm has a higher priority than the 256 bit-based algorithm, the first network device 410 may select the 128 bit-based algorithm.

According to an embodiment, in operation 413, the first network device 410 may transmit an NAS security mode command message to the UE 110.

The first network device 410 may transmit an NAS security mode command message including information for security configuration between the first network device 410 and the UE 110.

The NAS security mode command message may include ngKSI for identifying the KAMI, UE security capability information, information about the NAS encryption algorithm, and/or information about the NAS integrity protection algorithm. Further, the NAS security mode command message may include a K_AMF_change_flag indicating that a new K_{AMF} has been calculated, a flag requesting completion of an initial NAS message, and/or an anti-bidding down between architectures (ABBA) parameter.

If the first network device 410 receives information indicating that the length of K is 256 bits from the third network device 430, the first network device 410 may modify UE security capability information (e.g., UE security capability information of FIG. 14) and transmit an NAS security mode command message including the modified UE security capability information to the UE 110. For example, the first network device 410 may inform the UE 110 that the length of K is 256 bits using a portion not used in the UE security capability information (e.g., at least one of the 5G-EA7 field of octet 3/5G-IA7 field of octet 4 of the UE security capability information of FIG. 14, the EEA7 field of octet 5/5G-EIA7 field of octet 6, or the empty fields of octet 7-10, or any other value).

The NAS security mode command message may be a message first integrity-protected among the NAS messages.

The first network device 410 may generate an encryption key for NAS and an integrity protection key using the selected algorithm.

Although not shown, the first network device 410 may activate NAS uplink deciphering after transmitting the NAS security mode command message.

Although not shown, the UE 110 may verify the NAS security mode command message received from the first network device 410. For example, the UE 110 may verify the integrity protection of the NAS security mode command message by generating the K_{NASint} based on the NAS integrity protection algorithm selected by the first network device 410 and the K_{AMF}, and the UE 110 may identify whether the UE security capability information included in the NAS security mode command message corresponds to the UE security capability information stored in the UE 110.

According to an embodiment, in operation 414, the UE 110 may transmit an NAS security mode complete message to the first network device 410.

The UE 110 may generate an encryption key for NAS and an integrity protection key using the encryption algorithm and the integrity protection algorithm received through the NAS security mode command message, and cipher and integrity-protect the NAS security mode complete message using the NAS ciphering key and integrity protection key and transmit the same.

If the UE 110 receives UE security capability information having a value different from the UE security capability information transmitted through the UE registration request message from the first network device 410 in operation 413, the UE 110 may identify whether a value is changed in a field other than the portion not used in the UE security capability information (e.g., at least one of the 5G-EA7/5G-IA7 of octet 3/octet 4 of the UE security capability information of FIG. 14 or the EEA7/EEA8 of octet 5/octet 6 or the empty fields of octet 7-10 or other values). If there is no changed value in a field other than the unused field, the UE 110 may verify the corresponding NAS security mode command message. If a change occurs in a field other than the unused portion, the UE 110 may send a verify failure message.

The NAS security mode complete message may be a message first ciphered and integrity-protected among the NAS messages.

According to an embodiment, in operation 415, the first network device 410 may transmit a capability notification or an NGAP initial context setup (NGAP INITIAL CONTEXT SETUP) to the gNB 350. The capability notification (or NGAP initial context setup) may include information about the length of K between the UE 110 and the gNB 350 and/or UE security capability information. The UE security capability information may be the same as that transferred by the first network device 410 to the UE 110 through the NAS security mode command message (operation 413). In other words, it may be the same as or different from the UE security capability information sent by the UE 110 through the UE registration request message (operation 403). Other cases may include, e.g., a case in which the UE 110 does not receive the information about the length of K from the USIM 370 through operation 401/402, and thus the first network device 410 receives the corresponding information from the third network device 430 and then changes the UE security capability information in operation 413.

According to an embodiment, in operation 416, the gNB 350 may select an algorithm (hereinafter, referred to as an “AS security algorithm”) for security configuration of the UE 110 and the gNB 350. The AS security algorithm may include an AS encryption algorithm and an AS integrity algorithm.

The gNB 350 may select an AS security algorithm based on at least one of information about the length of K included in the capability notification received from the first network device 410 (e.g., this information may be included in a separate indicator, a separate parameter, or UE security capability information), length information about the RAND obtained in operation 411, UE security capability information, and information about the priority of the AS security algorithm of the gNB 350. The information about the AS security algorithm priority of the gNB 350 may include information about a list of AS security algorithms that may be used by the gNB 350. The information about the AS security algorithm priority of the gNB 350 may be about the priority (e.g., an alignment order itself) between the plurality of algorithms included in the list of algorithms available to the gNB 350.

In an embodiment, the gNB 350 may select an AS security algorithm based on the information about the length of K. For example, when the length of K is 128 bits, the gNB 350 may select a 128 bit-based algorithm. For example, when the length of K is 256 bits, the gNB 350 may select a 128 bit-based algorithm or a 256 bit-based algorithm. The algorithm for encryption and the algorithm for integrity protection may be algorithms based on the same or different numbers of bits.

In an embodiment, the gNB 350 may select the AS security algorithm based on the information about the length of K and the information about the algorithm priority. For example, when it is identified that the length of K is 128 bits and the 128 bit-based algorithm has a higher priority than the 256 bit-based algorithm in the information about the algorithm priority, the gNB 350 may select the 128 bit-based algorithm. For example, when it is identified that the length of K is 128 bits and the 256 bit-based algorithm has a higher priority than the 128 bit-based algorithm in the information about the algorithm priority, the gNB 350 may select the 128 bit-based algorithm. For example, when it is identified that the length of K is 256 bits and the 256 bit-based algorithm has a higher priority than the 128 bit-based algorithm in the information about the algorithm priority, the gNB 350 may select the 256 bit-based algorithm. For example, when it is identified that the length of K is 256 bits and the 128 bit-based algorithm has a higher priority than the 256 bit-based algorithm in the information about the algorithm priority, the gNB 350 may select the 128 bit-based algorithm. In this case, because a 128 bit-based algorithm needs to be used, the gNB 350 may truncate to 128 bits when keys (e.g., K_{UPenc}, K_{UPint}, K_{RRCenc}, K_{RRCint}, etc.) generated as described below have a length of 256 bits. However, even if K has a length of 256 bits among the above-described examples, when the only algorithm included in the security capability information about the UE is a 128 bit-based algorithm, the gNB 350 may select the 128 bit-based algorithm.

In an embodiment of the disclosure, the gNB 350 may select the AS security algorithm based on the information about the length of K and/or the information about the security capability of the UE. For example, when the length of K is 128 bits and the UE supports only the 128 bit-based algorithm, the gNB 350 may select the 128 bit-based algorithm. For example, when the length of K is 128 bits and the UE supports the 128 bit-based algorithm and the 256 bit-based algorithm, the gNB 350 may select the 128 bit-based algorithm. Further, e.g., when the length of K is 256 bits and the UE supports the 128 bit-based algorithm and the 256 bit-based algorithm, the gNB 350 may select the 128 bit-based algorithm or the 256 bit-based algorithm. In this case, the gNB 350 may select the 128 bit-based algorithm or the 256 bit-based algorithm based on the information about the security algorithm priority of the gNB 350. When the 256 bit-based algorithm has a higher priority than the 128 bit-based algorithm, the gNB 350 may select the 256 bit-based algorithm. When the 128 bit-based algorithm has a higher priority than the 256 bit-based algorithm, the gNB 350 may select the 128 bit-based algorithm.

The gNB 350 may select the AS encryption algorithm and the AS integrity protection algorithm as the same algorithm or different algorithms. For example, the gNB 350 may select both the AS encryption algorithm and the AS integrity protection algorithm as 128 bit-based or 256 bit-based algorithms. For example, the gNB 350 may select the 128 bit-based algorithm as the AS encryption algorithm, and may select the 256 bit-based algorithm as the AS integrity protection algorithm. For example, the gNB 350 may select the 256 bit-based algorithm as the AS encryption algorithm, and may select the 128 bit-based algorithm as the AS integrity protection algorithm.

According to an embodiment, in operation 417, the gNB 350 may transmit an AS security mode command message to the UE 110.

The gNB 350 may generate an encryption key (e.g., K_{RRCenc} or K_{UPenc}) and an integrity protection key (e.g., K_{RRCint} or K_{UPint}) to be used for AS security based on the selected algorithm. The AS security mode complete message may be a message first integrity-protected among the AS messages.

The AS security mode complete message may include information about the selected AS security algorithm (e.g., RRC and UP encryption and integrity protection algorithms). The AS security mode command message may be integrity-protected with the RRC integrity protection key based on the K_{gNB}.

If the gNB 350 identifies that the length of K is 256 bits (e.g., through the length of the RAND received through operation 411, or a separate indicator received from the first network device 410), but information indicating the length of K is not reflected in the UE security capability information, the gNB 350 may modify the UE security capability information (e.g., the UE security capability information of FIG. 14), and may transmit an AS security mode command message including the modified UE security capability information to the UE 110. For example, the gNB 350 may inform the UE 110 that the length of K is 256 bits using a portion not used in the UE security capability information (e.g., at least one of the 5G-EA7 field of octet 3/5G-IA7 field of octet 4 of the UE security capability information of FIG. 14, the EEA7 field of octet 5/5G-EIA7 field of octet 6, or the empty fields of octet 7-10, or any other value).

Although not shown in the drawings, the UE 110 may identify the received AS security mode command message. The operation of the UE 110 identifying the AS security mode command message may include content corresponding to the operation of the UE 110 identifying the NAS security mode command message. If the identification of the AS security mode command message is successful, the UE 110 may start RRC integrity protection and RRC downlink deciphering.

According to an embodiment, in operation 418, the UE 110 may transmit an AS security mode complete message to the gNB 350.

If the UE 110 receives UE security capability information having a value different from the UE security capability information transmitted through the UE registration request message from the gNB 350 in operation 417, the UE 110 may identify whether a value is changed in a field other than the portion not used in the UE security capability information (e.g., at least one of the 5G-EA7/5G-IA7 of octet 3/octet 4 of the UE security capability information of FIG. 14 or the EEA7/EEA8 of octet 5/octet 6 or the empty fields of octet 7-10 or other values). If there is no changed value in a field other than the unused field, the UE 110 may verify the corresponding AS security mode command message. If a change occurs in a field other than the unused portion, the UE 110 may send a verify failure message.

The AS security mode complete message may be encrypted and integrity-protected using an encryption key for AS and an integrity protection key.

The AS security mode complete message may be a message first ciphered and integrity-protected among the AS messages.

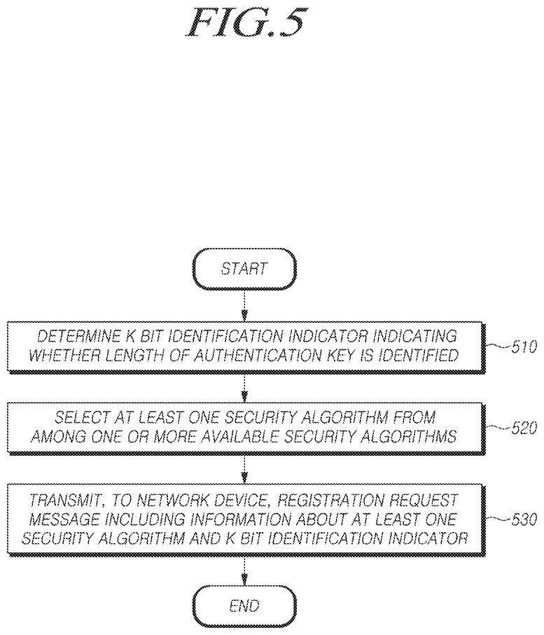

FIG. 5 illustrates an operation flow of a UE according to an embodiment of the disclosure.

Descriptions overlapping those described with reference to FIGS. 3A, 3B, and 4 may be omitted. The description of FIG. 5 may include all of the operations of the UE 110 of FIG. 4. The network device of FIG. 5 may correspond to the first network device 410 of FIG. 4, and the base station of FIG. 5 may correspond to the gNB 350 of FIG. 4.

Referring to FIG. 5, according to an embodiment, in operation 510, a UE may determine a K-bit identification indicator indicating whether the length of the authentication key is identified. Operation 510 may include some operations of operation 401, operation 402, and operation 403 of FIG. 4.

The UE may determine a K-bit identification indicator indicating whether the length of the authentication key K stored in the subscriber identification module (SIM) is identified.

Although it is exemplified that the length of the authentication key is either 128 bits or 256 bits, embodiments of the disclosure may be equally applied even when the length of the authentication key has a length other than 128 bits or 256 bits.

The UE may request information about the length of the authentication key from the subscriber identification module. Upon receiving the information about the length of the authentication key from the subscriber identification module, the UE may determine that the length of the authentication key is identified based on the information about the length of the authentication key. The UE may determine that the length of the authentication key is not identified when failing to receive the information about the length of the authentication key from the subscriber identification module.

Information about the length of K may be expressed as n (e.g., 1, 2, 3) bits. For example, the information about the length of K may have a value of “0” when the length of K is 128 bits, and may have a value of “1” when the length of K is 256 bits. For example, when there is K having a length (e.g., 192 bits) other than 128 bits and 256 bits, the information about the length of K may have a value of “00” for 128 bits, “01” for 192 bits, and “10” for 256 bits using three bits. The above-described values such as “0”, “1”, “00”, “01”, and “10” are all examples, and the information about the length of K may be expressed through various methods capable of indicating the length of K as well as n bits.

The K-bit identification indicator may refer to an indicator indicating whether the UE identifies the length of the authentication key. For example, when the UE identifies the length of the authentication key, the K-bit identification indicator may have a value of “1”, and when the UE does not identify the length of the authentication key, the K-bit identification indicator may have a value of “0”.

According to an embodiment, in operation 520, the UE may select at least one security algorithm from among one or more available security algorithms. Operation 520 may include some operations of operation 403 of FIG. 4.

The one or more algorithms available to the UE may mean all algorithms available to the UE for network security.

In an embodiment, the at least one security algorithm may include one or more of a security algorithm using a 128 bit key and a security algorithm using a 256 bit key. In the description, it is described that the at least one security algorithm includes only a security algorithm using a key of 128 bits or a key of 256 bits, but this is merely an example, and the at least one security algorithm may include a security algorithm using a key of a different length.

In an embodiment, when the length of the authentication key is not identified, the UE may select all of the one or more security algorithms. For example, when the one or more security algorithms are a 128 bit-based security algorithm and a 256 bit-based security algorithm, e.g., when the UE may not identify the length of the authentication key, the UE may select both the 128 bit-based security algorithm and the 256 bit-based security algorithm.

In an embodiment, when the length of the authentication key is identified, the UE may select a security algorithm using a key less than or equal to the length of the authentication key. For example, when the one or more security algorithms may be a 128 bit-based security algorithm and a 256 bit-based security algorithm, e.g., when the UE identifies that the length of the authentication key is 256 bits, the UE may select a 128 bit-based algorithm and a 256 bit-based algorithm. Further, e.g., when the UE identifies that the length of the authentication key is 128 bits, the UE may select the 128 bit-based algorithm even though the 256 bit-based algorithm is included in the one or more security algorithms. For example, when the one or more security algorithms available to the UE are 128 bit-based security algorithms and the UE identifies that the length of the authentication key is 256 bits, the UE may select only the 128 bit-based algorithm.

According to an embodiment, in operation 530, the UE may transmit, to the network device, a registration request message including information about at least one security algorithm and/or a K-bit identification indicator. Operation 530 may include all the contents of operation 403 of FIG. 4.

The network device may determine whether to request information about the length of K from the network, based on the information included in the registration request message transmitted from the UE.

According to an embodiment, although not shown in the drawings, the UE may receive information about the security algorithm selected from the network device or the base station connected to the UE.

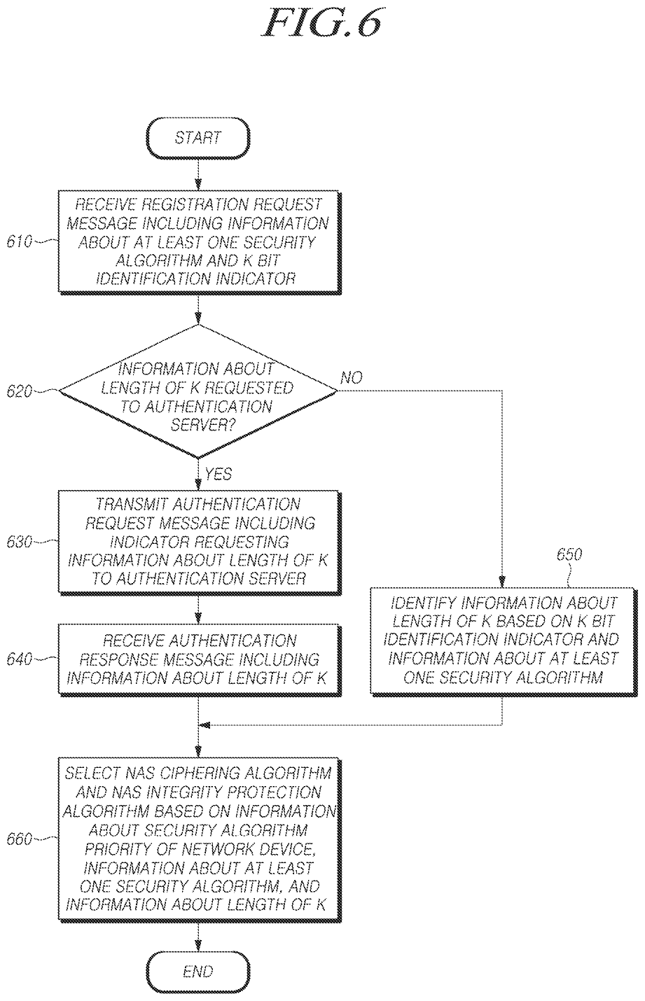

FIG. 6 illustrates an operation flow of a network device according to an embodiment of the disclosure.

In the description of FIG. 6, descriptions overlapping those described with reference to FIGS. 1A, 1B, 2A, 2B, 2C, 3A, 3B, 4, and 5 may be omitted. The description of FIG. 6 may relate to the operation of the first network device 410 of FIG. 4. The network device of FIG. 6 may be a device corresponding to the first network device 410 of FIG. 4. The UE of FIG. 6 may be a device corresponding to the UE 110 of FIG. 4 or the UE of FIG. 5. The base station of FIG. 6 may be the gNB 350 of FIG. 4 or a device corresponding to the base station of FIG. 5. The authentication server of FIG. 6 may be a device corresponding to the second network device 420 of FIG. 4.

Referring to FIG. 6, according to an embodiment, in operation 610, a network device may receive a registration request message including a K-bit identification indicator and/or information about at least one security algorithm. Operation 610 may include all the contents of operation 403 of FIG. 4.

The registration request message is a message corresponding to the N1 message transmitted from the UE to the network device in the initial authentication and key agreement procedure, and may include identification information (e.g., a subscription concealed identifier (SUCI) or a globally unique temporary identifier (5G-GUTI)) about the UE and security capability information (e.g., information about at least one security algorithm) about the UE.

The K-bit identification indicator may refer to an indicator indicating whether the UE identifies the length of the authentication key. For example, when the UE identifies the length of the authentication key, the K-bit identification indicator may have a value of “1”, and when the UE does not identify the length of the authentication key, the K-bit identification indicator may have a value of “0”. It is described that whether the UE 110 identifies the length of K is indicated based on the value indicated by the K-bit identification indicator, but this is merely an example, and when the UE 110 does not transmit the K-bit identification indicator to the first network device, the first network device 410 may identify that the UE does not identify the length of K.

The information about the at least one security algorithm may include information about at least one security algorithm selected by the UE from among one or more security algorithms in FIG. 5.

According to an embodiment, in operation 620, the network device may determine whether to request information about the length of K to the authentication server. Operation 620 may include the whole of operation 404 of FIG. 4. When it is determined to request information about the length of K to the authentication server, the network device may perform operation 630. When it is determined that the network device does not request information about the length of K to the authentication server, the network device may perform operation 650.

To determine whether the network device requests information about the length of K, the network device may determine whether only a security algorithm using a key having a length less than or equal to a first value is present in at least one security algorithm. In the following description, the first value may be 128 bits, and the second value may be 256 bits.

In an embodiment, when only a security algorithm using a key having a length less than or equal to a first value is present in the at least one security algorithm, it may be determined not to request information about the length of the authentication key to the authentication server.

In an embodiment, when there is a security algorithm using the key of the second value larger than the first value in the at least one security algorithm, the electronic device may determine that the K-bit identification indicator indicates whether the length of K is identified. For example, when the K-bit identification indicator indicates that the length of K is not identified, it may be determined to request information about the length of the authentication key. For example, when the K-bit identification indicator indicates that the length of the authentication key is identified, it may be determined not to request information about the length of the authentication key.

According to an embodiment, in operation 630, the network device may transmit, to the authentication server, an authentication request message including an indicator for requesting information about the length of K. Operation 630 may include the whole of operation 405 of FIG. 4.

When the first network device determines to request information about the length of K to the authentication server, the authentication request message may include a “K-bit request indicator” for requesting information about the length of K. When it is determined that the network device does not request information about the length of K to the authentication server, the authentication request message may not include a “K-bit request indicator” for requesting information about the length of K. For example, when the first network device identifies the length of K through the registration request message received from the UE 110 or, although failing to identify the length of K, receives that the UE does not support the 256 bit-based security algorithm, the network device may not include the K-bit request indicator in the authentication request message transmitted to the authentication server.

According to an embodiment, in operation 640, the network device may receive an authentication response message including information about the length of K from the authentication server. Operation 640 may include all the contents of operation 409 of FIG. 4.

According to an embodiment, in operation 650, the network device may identify the information about the length of K based on the K-bit identification indicator and/or information about at least one security algorithm.

For example, when there is only a 128 bit-based algorithm in the information about the at least one security algorithm and the K-bit identification indicator indicates that the length of K is not identified, it may be identified that K is 128 bits. For example, when the 128 bit-based algorithm and the 256 bit-based algorithm are included in the information about the at least one algorithm, and the K-bit identification indicator indicates that the length of K is identified, it may be identified that the length of K is 256 bits.

According to an embodiment, in operation 660, the network device may select the NAS encryption algorithm and the NAS integrity protection algorithm, based on the information about the length of K, the information about at least one security algorithm, and/or the information about the security algorithm priority of the network device. Operation 660 may include all the contents of operation 412 of FIG. 4.

When it is identified that the authentication procedure (e.g., operation 411) of the UE is successful, the network device may select the NAS security algorithm. The NAS security algorithm may include an NAS encryption algorithm and/or an NAS integrity protection algorithm.

The network device may select the NAS security algorithm based on at least one of information about the length of K identified based on the message received from the UE or the network device, information about the priority of the NAS security algorithm of the network device, and security capability information about the UE obtained from the UE or the network device. The information about the NAS security algorithm priority of the network device may include information about a list of algorithms supportable by the network device. For example, the information about the NAS security algorithm priority may indicate information about the priority (e.g., an order) between the plurality of algorithms included in the list.

In an embodiment, the network device may select the NAS security algorithm based on the information about the length of K identified based on the message (e.g., the registration request message of operation 403 or the authentication response message of operation 409) received from the UE or the network. For example, when the length of K is 128 bits, the network device may select a 128 bit-based algorithm. For example, when the length of K is 256 bits, the network device may select a 128 bit-based algorithm or a 256 bit-based algorithm.

In an embodiment, the network device may select the NAS encryption algorithm and the NAS integrity protection algorithm as the same or different algorithms. For example, both the NAS encryption algorithm and the NAS integrity protection algorithm may be selected as 256 bit-based algorithms. For example, both the NAS encryption algorithm and the NAS integrity protection algorithm may be selected as 128 bit-based algorithms. For example, the NAS encryption algorithm may be selected as a 128 bit-based algorithm and may be selected as a 256 bit-based algorithm for the NAS integrity protection algorithm. For example, the NAS encryption algorithm may be selected as a 256 bit-based algorithm and may be selected as a 128 bit-based algorithm for the NAS integrity protection algorithm.

In an embodiment, the network device may select the NAS security algorithm based on the information about the length of K and/or the information about the algorithm priority. For example, when it is identified that the length of K is 128 bits and the 128 bit-based algorithm has a higher priority than the 256 bit-based algorithm in the information about the algorithm priority, the network device may select the 128 bit-based algorithm. For example, when it is identified that the length of K is 128 bits and the 256 bit-based algorithm has a higher priority than the 128 bit-based algorithm in the information about the algorithm priority, the network device may select the 128 bit-based algorithm. For example, when it is identified that the length of K is 256 bits and the 256 bit-based algorithm has a higher priority than the 128 bit-based algorithm in the information about the algorithm priority, the network device may select the 256 bit-based algorithm. For example, when it is identified that the length of K is 256 bits and the 128 bit-based algorithm has a higher priority than the 256 bit-based algorithm in the information about the algorithm priority, the network device may select the 128 bit-based algorithm. In this case, because a 128 bit-based algorithm needs to be used, the network device may truncate to 128 bits when keys (e.g., K_{NASenc}, K_{NASint}, etc.) generated as described below have a length of 256 bits. However, even if K has a length of 256 bits among the above-described examples, when the only algorithm included in the security capability information about the UE is a 128 bit-based algorithm, the network device may select the 128 bit-based algorithm.

In an embodiment of the disclosure, the network device may select the NAS security algorithm based on the information about the length of K and/or the information about the security capability of the UE. For example, when the length of K is 128 bits and the UE supports only the 128 bit-based algorithm, the network device may select the 128 bit-based algorithm. For example, when the length of K is 128 bits and the UE supports the 128 bit-based algorithm and the 256 bit-based algorithm, the network device may select the 128 bit-based algorithm. Further, e.g., when the length of K is 256 bits and the UE supports the 128 bit-based algorithm and the 256 bit-based algorithm, the network device may select the 128 bit-based algorithm or the 256 bit-based algorithm. In this case, the network device may select the 128 bit-based algorithm or the 256 bit-based algorithm based on the information about the security algorithm priority of the network device. When the 256 bit-based algorithm has a higher priority than the 128 bit-based algorithm, the network device may select the 256 bit-based algorithm. When the 128 bit-based algorithm has a higher priority than the 256 bit-based algorithm, the network device may select the 128 bit-based algorithm.

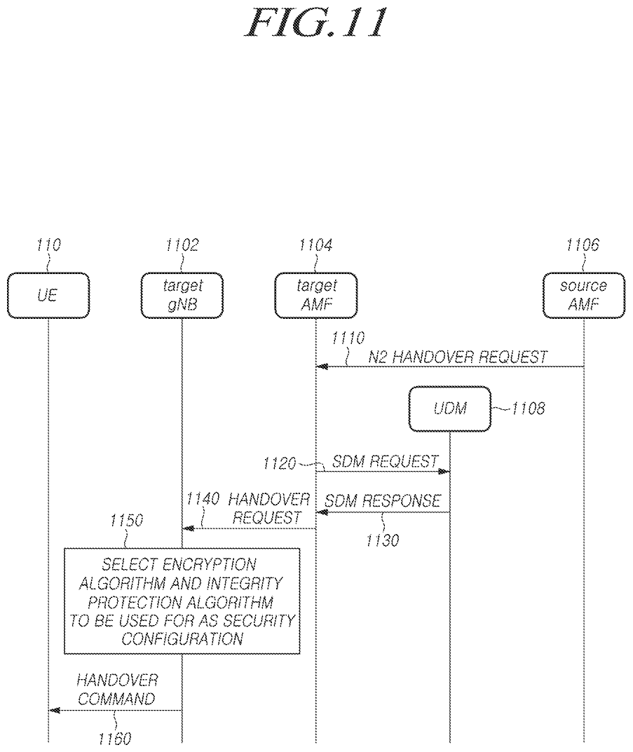

In an embodiment, although not illustrated in the drawings, when receiving a handover request from the base station, the network device may transmit, to another network device (e.g., target AMF 1104 of FIG. 11), the first handover request message including information about at least one security algorithm of the UE and/or information about an authentication key of the UE (e.g., operation 1110 of FIG. 11).

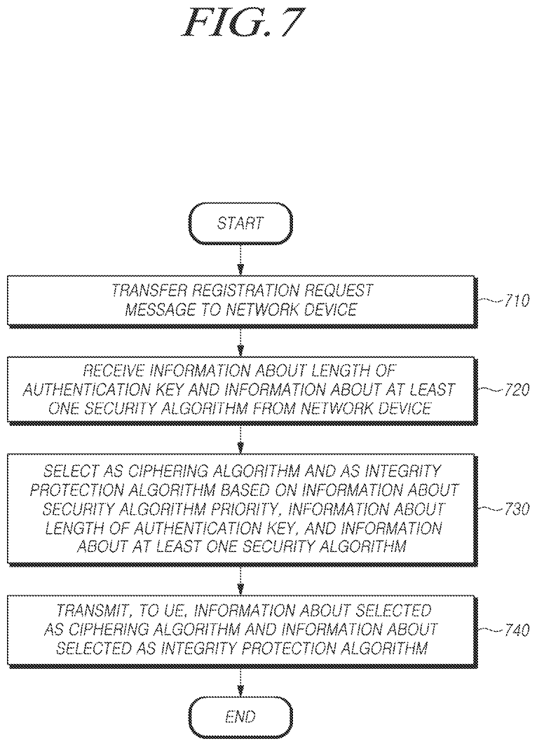

FIG. 7 illustrates an operation flow of a base station according to an embodiment of the disclosure.

In the description of FIG. 7, descriptions overlapping those described with reference to FIGS. 1A, 1B, 2A, 2B, 2C, 3A, 3B, and 4 to 6 may be omitted. The description of FIG. 7 may be a description of the operation of the gNB 350 of FIG. 4. The base station of FIG. 7 may be a device corresponding to the gNB 350 of FIG. 4. The UE of FIG. 7 may be a device corresponding to the UE 110 of FIG. 4. The network device of FIG. 7 may be a device corresponding to the first network device 410 of FIG. 4.

Referring to FIG. 7, according to an embodiment, in operation 710, a base station may transfer the registration request message to a network device. Operation 710 may include the whole of operation 403 of FIG. 4.

The UE may directly transmit the registration request message to the network device, but the UE may transmit the registration request message to the network device through the base station. For example, the base station may transparently forward the registration request message received from the UE to the network device.

According to an embodiment, in operation 720, the base station may receive information about at least one security algorithm and/or information about the length of the authentication key from the network device. Operation 720 may include all the contents of operation 415 of FIG. 4.

The base station may receive a capability notification from the network device. The capability notification may include information about the length of K of the UE and/or information about at least one security algorithm of the UE.

According to an embodiment, in operation 730, the base station may select the AS encryption algorithm and the AS integrity protection algorithm based on the information about the at least one security algorithm, the information about the length of the authentication key, and/or the information about the security algorithm priority. Operation 730 may include the whole of operation 416 of FIG. 4.

The AS security algorithm may include an AS encryption algorithm and/or an AS integrity protection algorithm.

The base station may select the AS security algorithm based on at least one of information about the length of K, UE security capability information, and information about the priority of the AS security algorithm of the base station included in the capability notification received from the network device. The information about the AS security algorithm priority of the base station may include information about a list of AS security algorithms that the base station may use. The information about the AS security algorithm priority of the base station may be about the priority (e.g., an alignment order itself) between the plurality of algorithms included in the list of algorithms available to the base station.

In an embodiment, the base station may select an AS security algorithm based on the information about the length of K. For example, when the length of K is 128 bits, the base station may select a 128 bit-based algorithm. For example, when the length of K is 256 bits, the base station may select a 128 bit-based algorithm or a 256 bit-based algorithm. The algorithm for encryption and the algorithm for integrity protection may be algorithms based on the same or different numbers of bits.

In an embodiment, the base station may select the AS security algorithm based on the information about the length of K and/or the information about the algorithm priority. For example, when it is identified that the length of K is 128 bits and the 128 bit-based algorithm has a higher priority than the 256 bit-based algorithm in the information about the algorithm priority, the base station may select the 128 bit-based algorithm. For example, when it is identified that the length of K is 128 bits and the 256 bit-based algorithm has a higher priority than the 128 bit-based algorithm in the information about the algorithm priority, the base station may select the 128 bit-based algorithm. For example, when it is identified that the length of K is 256 bits and the 256 bit-based algorithm has a higher priority than the 128 bit-based algorithm in the information about the algorithm priority, the base station may select the 256 bit-based algorithm. For example, when it is identified that the length of K is 256 bits and the 128 bit-based algorithm has a higher priority than the 256 bit-based algorithm in the information about the algorithm priority, the base station may select the 128 bit-based algorithm. In this case, because a 128 bit-based algorithm needs to be used, the base station may truncate to 128 bits when keys (e.g., K_{UPenc}, K_{UPint}, K_{RRCenc}, K_{RRCint}, etc.) generated as described below have a length of 256 bits. However, even if K has a length of 256 bits among the above-described examples, when the only algorithm included in the security capability information about the UE is a 128 bit-based algorithm, the base station may select the 128 bit-based algorithm.

In an embodiment of the disclosure, the base station may select the AS security algorithm based on the information about the length of K and/or the information about the security capability of the UE. For example, when the length of K is 128 bits and the UE supports only the 128 bit-based algorithm, the base station may select the 128 bit-based algorithm. For example, when the length of K is 128 bits and the UE supports the 128 bit-based algorithm and the 256 bit-based algorithm, the base station may select the 128 bit-based algorithm. Further, e.g., when the length of K is 256 bits and the UE supports the 128 bit-based algorithm and the 256 bit-based algorithm, the base station may select the 128 bit-based algorithm or the 256 bit-based algorithm. In this case, the base station may select the 128 bit-based algorithm or the 256 bit-based algorithm based on the information about the security algorithm priority of the base station. When the 256 bit-based algorithm has a higher priority than the 128 bit-based algorithm, the base station may select the 256 bit-based algorithm. When the 128 bit-based algorithm has a higher priority than the 256 bit-based algorithm, the base station may select the 128 bit-based algorithm.

The base station may select the AS encryption algorithm and the AS integrity protection algorithm as the same algorithm or different algorithms. For example, the base station may select both the AS encryption algorithm and the AS integrity protection algorithm as 128 bit-based or 256 bit-based algorithms. For example, the base station may select the 128 bit-based algorithm as the AS encryption algorithm, and may select the 256 bit-based algorithm as the AS integrity protection algorithm. For example, the base station may select the 256 bit-based algorithm as the AS encryption algorithm, and may select the 128 bit-based algorithm as the AS integrity protection algorithm.

According to an embodiment, in operation 740, the base station may transmit information about the selected AS encryption algorithm and/or information about the AS integrity protection algorithm to the UE. Operation 740 may include the whole of operation 417 of FIG. 4.

The base station may transmit an AS security mode command message to the UE. The AS security mode command message may include information about the AS security algorithm (e.g., RRC and UP encryption and integrity protection algorithms) selected by the base station.

The information about the length of the authentication key may include an indicator indicating that the authentication key is either 128 bits or 256 bits.

The information about the at least one security algorithm may include information about at least one of a 128 bit-based security algorithm and a 256 bit-based security algorithm.

The AS security mode command message may be integrity-protected with the RRC integrity protection key based on the K_{gNB}.

The base station may generate an encryption key (e.g., K_{RRCenc} or K_{UPenc}) and an integrity protection key (e.g., K_{RRCint} or K_{UPint}) to be used for AS security based on the selected algorithm. The AS security mode complete message may be a message first integrity-protected among the AS messages.

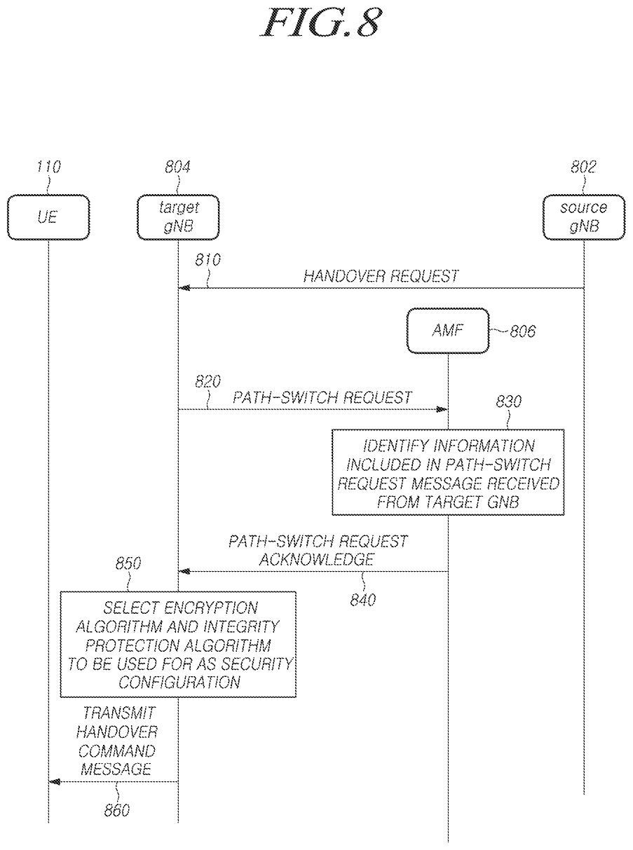

Although not shown in the drawings, the base station may determine the handover of the UE based on the measurement report received from the UE. When the base station determines the handover of the UE, the base station may transmit, to the target base station, a handover request message including information about the length of K of the UE and security capability information (including information about at least one security algorithm) about the UE (e.g., operation 810 of FIG. 8).

FIG. 8 illustrates a signaling flow between entities in an Xn handover process according to an embodiment of the disclosure.

Referring to FIG. 8, in the Xn handover process, a target gNB 804 may receive information for selecting the AS algorithm (e.g., information about the length of K, security capability information about the UE, and information about the AS algorithm selected by the source gNB) from a source gNB 802 or an AMF 806, and may perform AS security configuration with a UE 110 based thereon. The source gNB 802 and the target gNB 804 of FIG. 8 may correspond to the gNB 350 of FIG. 4 and the base stations of FIGS. 4 to 7. The AMF 806 of FIG. 4 may be a device corresponding to the network device of FIGS. 4 and 7 and the first network device of FIG. 6. FIG. 8 may regard an operation after the source gNB 802, which is the source base station, selects an AS algorithm based on information about the length of K and UE security capability information, according to what has been described with reference to FIGS. 4 to 7.

According to an embodiment, in operation 810, the source gNB 802 may transmit a handover request message to the target gNB 804.

The handover request message is a message transmitted from the source gNB 802 to the target gNB 804 through the Xn interface, and may include information (e.g., target cell identity (ID), protocol data unit (PDU) session list, etc.) necessary for handover.

Although not illustrated in the drawings, the UE 110 may transmit a measurement report to the source gNB 802. The source gNB 802 may determine that the UE 110 performs a handover from the source gNB 802 to the target gNB 804, based on information (e.g., the received signal strength (e.g., reference signal received power (RSRP)) of the serving cell and neighboring cell) included in the measurement report.

When the source gNB 802 determines the handover to the target gNB 804, the source gNB 802 may transmit a handover request message to the target gNB 804.

In an embodiment of the disclosure, the handover request message may include at least one of UE security capability information (e.g., UE security capability information of FIG. 4), information about the AS encryption algorithm used by the source gNB 802 for AS security configuration with the UE 110, information about the AS integrity protection algorithm, or information about the length of K of the UE 110. The information about the length of K of the UE 110 may be, e.g., the length of the algorithm used by the source gNB 802 with the UE 110 or may be provided using a separate parameter, provided through a separate indicator, or included in the UE security capability information.

The UE security capability information may correspond to UE security capability information included in the registration request message in operation 403 of FIG. 4. In other words, information about at least one security algorithm selected by the UE may be included. The UE security capability information may include information about the AS encryption algorithm and/or the AS integrity algorithm that may be used by the UE.

The information about the AS encryption algorithm and/or the information about the AS integrity protection algorithm used by the source gNB 802 for the AS security configuration with the UE 110 may include information about the algorithm (e.g., a 128 bit-based algorithm or a 256 bit-based algorithm) used for the security configuration with the UE 110 before the source gNB 802 determines a handover to the target gNB 804.

The information about the length of K of the UE 110 may include information about the length of K, which is an authentication key of the UE 110 stored in the UE 110 and the network (e.g., UDM).

Although not illustrated in the drawings, the target gNB 804 may determine to perform a handover based on the received handover request message, and then may transmit a handover request response message to the source gNB 802. Thereafter, the UE 110 and the target gNB 804 may perform random access (RACH), and RRCReconfiguration may be performed accordingly.

According to an embodiment, in operation 820, the target gNB 804 may transmit a path-switch request message to the AMF 806. In response to receiving the handover request message from the source gNB 802, the target gNB 804 may transmit, to the AMF 806, a path-switch request message for requesting a path switch of the UE 110.

The path-switch request message may include at least one piece of information (e.g., UE security capability information, information about the encryption algorithm used by the source gNB 802 to set AS security, information about the integrity protection algorithm, and information about the length of K of the UE 110) received by the target gNB 804 from the source gNB 802 through the handover request message.

According to an embodiment, in operation 830, the AMF 806 may determine whether the information included in the path-switch request message received from the target gNB 804 matches the information stored in the AMF 806. For example, the AMF 806 may determine whether the UE security capability information included in the path-switch request message received from the target gNB 804 matches the UE security capability information stored in the AMF 806. For example, the AMF 806 may determine whether the information about the length of K included in the path-switch request message received from the target gNB 804 matches the information about the length of K stored in the AMF 806. When the information stored in the AMF 806 does not match the information received from the target gNB 804, the AMF 806 may transmit the information stored in the AMF 806 to the target gNB 804. Since the information for selecting the security algorithm received by the target gNB 804 from the source gNB 802 may be inaccurate, the AMF 806 may verify the information and, when the accurate information is not included, may provide the accurate information to the target gNB 804.

According to an embodiment, in operation 840, the AMF 806 may transmit a path-switch request acknowledge message to the target gNB 804. The AMF 806 may transmit a path-switch request acknowledge message to the target gNB 804 in response to receiving the path-switch request message from the target gNB 804.

The path-switch request acknowledge message may include information about UE security capability and/or information about the length of K, and if there is non-matching information of the information transmitted by the target gNB 804 and the information stored by the AMF 806 in operation 830, the information stored by the AMF 806 may be transmitted through the path-switch request acknowledge message.

According to an embodiment, in operation 850, the target gNB 804 may select an encryption algorithm and/or an integrity protection algorithm to be used for AS security configuration with the UE 110. The target gNB 804 may select the AS security algorithm based on UE security capability information included in the path-switch request acknowledge message or the handover request message, information about the length of K, and/or information about the algorithm priority of the target gNB 804.

In an embodiment, the target gNB 804 may select an algorithm for AS security configuration with the UE. After receiving the capability notification from the AMF 806, the target gNB 804 may select an algorithm for AS security configuration with the UE. The process of selecting the AS security algorithm by the target gNB 804 according to operation 850 may include all of the operation contents (e.g., operation 415 and operation 730) for selecting the AS security algorithm of the gNB or the base station described above with reference to the drawings.

According to an embodiment, in operation 860, the target gNB 804 may transmit a handover command message to the UE 110. The handover command message may include information about the AS encryption algorithm and the AS integrity protection algorithm selected by the target gNB 804.

The target gNB 804 may transmit the AS encryption algorithm and/or the AS integrity protection algorithm through the handover command message only when the selected AS encryption algorithm and/or the AS integrity protection algorithm are different from the AS encryption algorithm and/or the AS integrity protection algorithm included in the handover request message received from the source gNB 802. In other words, if the AS encryption algorithm and/or the AS integrity protection algorithm used by the source gNB 802 is different from the AS encryption algorithm and/or the AS integrity protection algorithm selected by the target gNB 804, the AS encryption algorithm and/or the AS integrity protection algorithm may be transmitted to the UE 110, and if they are the same, the AS encryption algorithm and/or the AS integrity protection algorithm may not be transmitted.

In an embodiment, if the handover command message received from the target gNB 804 does not include the information about the AS encryption algorithm or the information about the AS integrity protection algorithm, the UE 110 may use the AS encryption algorithm and/or the AS integrity protection algorithm used for security configuration with the source gNB 802 as it is.

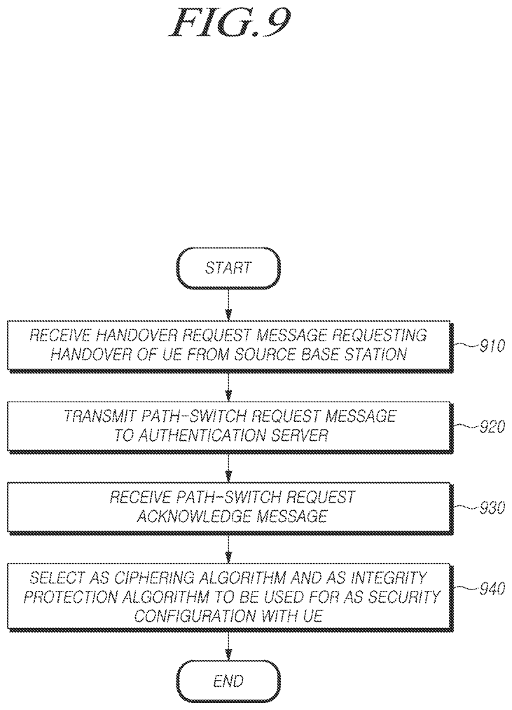

FIG. 9 illustrates an operation flow of a base station according to an embodiment of the disclosure.

The base station of FIG. 9 may be a device corresponding to the target gNB 804 of FIG. 8, and the source base station may be a device corresponding to the source gNB 802. Further, the network device of FIG. 9 may be a device corresponding to the AMF 310 of FIG. 4 and the AMF 806 of FIG. 8. FIG. 9 may illustrate operations of the target gNB 804 in the Xn handover process of FIG. 8.

Referring to FIG. 9, according to an embodiment, in operation 910, a base station may receive a handover request message for requesting handover of a UE from a source base station. Operation 910 may include all of the operations of operation 810 of FIG. 8.

In an embodiment, the base station may receive the handover request message from the source base station. The handover request message is a message transmitted from the source gNB 802 to the base station through the Xn interface, and may include information (e.g., target cell ID, PDU session list, etc.) necessary for handover.

Although not illustrated in the drawings, the UE may transmit a measurement report to the source base station. The source base station may determine that the UE performs a handover from the source base station to the base station, based on information (e.g., the received signal strength (e.g., RSRP) of the serving cell and neighboring cell) included in the measurement report. When determining the handover to the base station, the source base station may transmit the handover request message to the base station.

The handover request message may include at least one of UE security capability information (e.g., UE security capability information of FIG. 4), information about the AS encryption algorithm used by the source base station for AS security configuration with the UE and/or information about the AS integrity protection algorithm, or information about the length of the authentication key of the UE.

The UE security capability information may include information about at least one security algorithm. The UE security capability information may include information about the AS encryption algorithm and/or the AS integrity algorithm that may be used by the UE.

The information about the AS encryption algorithm and/or the information about the AS integrity protection algorithm used by the source base station for the AS security configuration with the UE may include information about the algorithm (e.g., a 128 bit-based algorithm or a 256 bit-based algorithm) used for the security configuration with the UE before the source base station determines a handover to the base station. The information about the length of the authentication key of the UE may include information about the length of the authentication key of the UE stored in the UE and the network (e.g., UDM).

According to an embodiment, in operation 920, the base station may transmit a path-switch request message to the network device. Operation 920 may include all the contents of operation 820 of FIG. 8. In response to receiving the handover request message from the source base station, the base station may transmit a path-switch request message for requesting a path switch of the UE to the network device.

The path-switch request message may include at least one piece of information (e.g., UE security capability information, information about the encryption algorithm used by the source base station to set AS security and/or information about the integrity protection algorithm, and information about the length of the authentication key of the UE) received by the base station from the source base station through the handover request message.

According to an embodiment, in operation 930, the base station may receive the path-switch request acknowledge message from the network device. Operation 930 may include all of the operations of operation 840 of FIG. 8.

The network device may transmit a path-switch request acknowledge message to the base station in response to receiving the path-switch request message from the base station. The path-switch request acknowledge message may include information about UE security capability and/or information about the length of the authentication key, and if the network device has non-matching information in the information transmitted by the base station and the information stored in the network device, the network device may transmit the information stored in the network device through the path-switch request acknowledge message.

According to an embodiment, in operation 940, the base station may select the AS encryption algorithm and/or the AS integrity protection algorithm to be used for AS security configuration with the UE. The base station may select the AS security algorithm based on UE security capability information included in the path-switch request acknowledge message or the handover request message, information about the length of K, and/or information about the algorithm priority of the base station.

The base station may select an algorithm for AS security configuration with the UE. After receiving the capability notification from the network device, the base station may select the algorithm for AS security configuration with the UE. The base station may select an algorithm (hereinafter, referred to as “AS security algorithm”) for security configuration of the UE and the base station, based on at least one of information about the length of K, information about the priority of the algorithm for security configuration with the UE of the base station, or security capability information about the UE, received from the UE or the base station. The AS security algorithm may include an AS encryption algorithm and/or an AS integrity protection algorithm. The base station may include a list of AS encryption algorithms available to the base station and a list of AS integrity protection algorithms available to the base station. The information about the priority of the AS security algorithm of the base station may indicate the information about the priority (which may have a form of, e.g., an order sorted in the list) between the plurality of algorithms included in the list of algorithms supportable by the base station.

The base station may select the AS security algorithm based on the information about the length of K identified from the network device. For example, when the length of K is 128 bits, the base station may select a 128 bit-based algorithm. For example, when the length of K is 256 bits, the base station may select a 128 bit-based algorithm or a 256 bit-based algorithm. The algorithm for encryption and the algorithm for integrity protection may be algorithms based on the same or different numbers of bits.

The base station may select the AS security algorithm based on the information about the length of K and/or the information about the algorithm priority. For example, when it is identified that the length of K is 128 bits and the 128 bit-based algorithm has a higher priority than the 256 bit-based algorithm in the information about the algorithm priority, the base station may select the 128 bit-based algorithm. For example, when it is identified that the length of K is 128 bits and the 256 bit-based algorithm has a higher priority than the 128 bit-based algorithm in the information about the algorithm priority, the base station may select the 128 bit-based algorithm. For example, when it is identified that the length of K is 256 bits and the 256 bit-based algorithm has a higher priority than the 128 bit-based algorithm in the information about the algorithm priority, the base station may select the 256 bit-based algorithm. For example, when it is identified that the length of K is 256 bits and the 128 bit-based algorithm has a higher priority than the 256 bit-based algorithm in the information about the algorithm priority, the base station may select the 128 bit-based algorithm. In this case, because a 128 bit-based algorithm needs to be used, the base station may truncate to 128 bits when keys (e.g., K_{UPenc}, K_{UPint}, K_{RRCenc}, K_{RRCint}, etc.) generated as described below have a length of 256 bits. However, even if K has a length of 256 bits among the above-described examples, when the only algorithm included in the security capability information about the UE is a 128 bit-based algorithm, the base station may select the 128 bit-based algorithm.

The base station may select the AS security algorithm based on the information about the length of K and/or the information about the security capability of the UE. For example, when the length of K is 128 bits and the UE supports only the 128 bit-based algorithm, the base station may select the 128 bit-based algorithm. For example, when the length of K is 128 bits and the UE supports the 128 bit-based algorithm and the 256 bit-based algorithm, the base station may select the 128 bit-based algorithm. Further, e.g., when the length of K is 256 bits and the UE supports the 128 bit-based algorithm and the 256 bit-based algorithm, the base station may select the 128 bit-based algorithm or the 256 bit-based algorithm. In this case, the base station may select the 128 bit-based algorithm or the 256 bit-based algorithm based on the information about the security algorithm priority of the base station. When the 256 bit-based algorithm has a higher priority than the 128 bit-based algorithm, the base station may select the 256 bit-based algorithm. When the 128 bit-based algorithm has a higher priority than the 256 bit-based algorithm, the base station may select the 128 bit-based algorithm.

The AS encryption algorithm and the AS integrity protection algorithm may be selected as the same or different. For example, the base station may select both the AS encryption algorithm and the AS integrity protection algorithm as 128 bit-based or 256 bit-based algorithms. For example, the base station may select the 128 bit-based algorithm as the AS encryption algorithm, and may select the 256 bit-based algorithm as the AS integrity protection algorithm. For example, the base station may select the 256 bit-based algorithm as the AS encryption algorithm, and may select the 128 bit-based algorithm as the AS integrity protection algorithm.

According to an embodiment, although not shown in the drawings, the base station may transmit a handover command message to the UE. The handover command message may include information about the AS encryption algorithm and the AS integrity protection algorithm selected by the base station.

The base station may transmit the AS encryption algorithm and/or the AS integrity protection algorithm through the handover command message only when the selected AS encryption algorithm and/or the AS integrity protection algorithm are different from the AS encryption algorithm and/or the AS integrity protection algorithm included in the handover request message received from the base station. In other words, if the AS encryption algorithm and/or the AS integrity protection algorithm used by the source base station is different from the AS encryption algorithm and/or the AS integrity protection algorithm selected by the base station, the AS encryption algorithm and/or the AS integrity protection algorithm may be transmitted to the UE, and if they are the same, the AS encryption algorithm and/or the AS integrity protection algorithm may not be transmitted. If the handover command message received from the base station does not include the information about the AS encryption algorithm or the information about the AS integrity protection algorithm, the UE may use the AS encryption algorithm and/or the AS integrity protection algorithm used for security configuration with the source base station as it is.

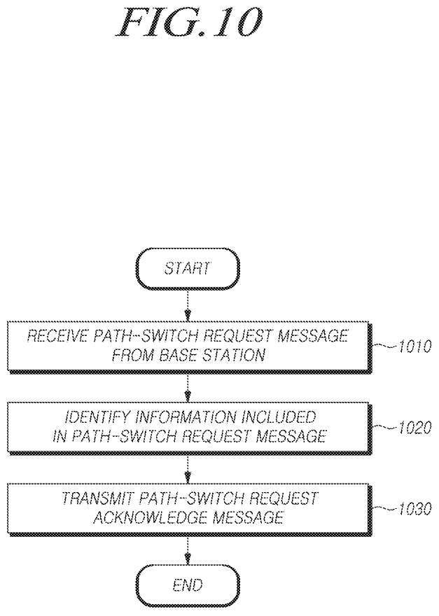

FIG. 10 illustrates an operation flow of a network device according to an embodiment of the disclosure.

The network device of FIG. 10 may be a device corresponding to the AMF 806 of FIG. 8. The base station of FIG. 10 may be a device corresponding to the target gNB 804 of FIG. 8. The source base station may be a device corresponding to the source gNB 802 of FIG. 8. Further, the first network device of FIG. 9 may correspond to the AMF 310 of FIG. 4 and the AMF 806 of FIG. 8. FIG. 10 may illustrate operations of the AMF 310 when the AMF 310 completes selection of an algorithm for NAS security configuration according to FIG. 4, transmits a capability notification to the gNB 350, and then the UE 110 performs a handover from the gNB 350 to another gNB, and may illustrate operations of the AMF 806 in the Xn handover process of FIG. 8.

Referring to FIG. 10, according to an embodiment, in operation 1010, a network device may receive a path-switch request message from a base station. Operation 1010 may include the whole of operation 820 of FIG. 8.

The network device may receive a path-switch request message from the base station. In response to receiving the handover request message from the source base station, the base station may transmit a path-switch request message for requesting a path switch of the UE 110 to the network device.

The path-switch request message may include at least one piece of information (e.g., UE security capability information, information about the encryption algorithm used by the source base station to set AS security and/or information about the integrity protection algorithm, and information about the length of the authentication key of the UE) received by the base station from the source base station through the handover request message.

According to an embodiment, in operation 1020, the network device may identify information included in the path-switch request message. Operation 1020 may include the whole of operation 830 of FIG. 9.

The network device may determine whether the information included in the path-switch request message received from the base station matches the information stored in the network device. For example, the network device may determine whether the UE security capability information included in the path-switch request message received from the base station matches the UE security capability information stored in the network device. For example, the network device may determine whether the information about the length of K included in the path-switch request message received from the base station matches the information about the length of K stored in the network device. When the information (second information) stored in the network device does not match the information (first information) received from the base station, the network device may transmit the information (second information) stored in the network device to the base station.

According to an embodiment, in operation 1030, the network device may transmit a path-switch request acknowledge message to the base station. Operation 1030 may include all of the operations of operation 840 of FIG. 8.

The network device may transmit a path-switch request acknowledge message to the base station in response to receiving the path-switch request message from the base station. The path-switch request acknowledge message may include information about UE security capability and/or information about the length of the authentication key, and if the network device has non-matching information in the information transmitted by the base station and the information stored in the network device, the network device may transmit the information stored in the network device through the path-switch request acknowledge message.

FIG. 11 illustrates a signaling flow between entities in an N2 handover process according to an embodiment of the disclosure.

Referring to FIG. 11, information about the length of K may be transmitted and received between the UE, the target gNB, the source AMF, the target AMF, and the UDM during the N2 handover process. FIG. 11 may assume that, as described with reference to FIG. 4, each entity obtains information about the length of K through the authentication procedure between the UE 110 and the network entities and, based thereupon, each of the AMF 310 and the gNB 350 selects an algorithm for AS security and NAS. The UE 110 of FIG. 11 may be a UE corresponding to the UE 110 of FIG. 4. Source AMF 1106 of FIG. 11 may correspond to the AMF 310 of FIG. 4.

Referring to FIG. 11, according to an embodiment, in operation 1110, a source AMF 1106 may transmit an N2 handover request message to a target AMF 1104. The N2 handover request message may include at least one of an algorithm for security configuration supported by the UE 110 and information about the length of K. The information about the length of K of the UE 110 may be, e.g., the length of the algorithm used by the source gNB 802 with the UE 110 or may be provided using a separate parameter, provided through a separate indicator, or included in the UE security capability information.

Although not illustrated in the drawings, the UE 110 may transmit the measurement report to the source gNB (e.g., the source gNB 802) connected to the UE 110. The source gNB may determine the handover of the UE 110 based on the measurement report received from the UE 110. When the source gNB determines the handover of the UE 110, the source gNB may transmit the handover request to the source AMF 1106. The source AMF 1106 may transmit the handover request to the target AMF 1104 in response to receiving the handover request from the source gNB.

According to an embodiment, in operation 1120, the target AMF 1104 may transmit a subscription data management (SDM) request message to a UDM 1108.

When the N2 handover request message received from the source AMF 1106 does not include information about the length of K, the target AMF 1104 may request information about the length of K from the UDM 1108 through the SDM request message. For example, if the handover request message received from the source AMF 1106 does not include information about the length of K, the SDM request message may include a K-bit request for requesting information about the length of K. For example, if the handover request message received from the source AMF 1106 includes information about the length of K, the SDM request message may not include a K-bit request. For example, even if the handover request message received from the source AMF 1106 includes information about the length of K, if it is determined that it is necessary to check with the UDM 1108, the SDM request message may not include the K-bit request.

When the target AMF 1104 does not receive the information about the length of K from the source AMF 1106 even though the target AMF 1104 identifies that the UE supports the 256 bit-based algorithm in the UE security capability information, the target AMF 1104 may transmit the K-bit request to the UDM 1108 through the SDM request message.

When the target AMF 1104 identifies that the UE supports only the 128 bit-based algorithm in the UE security capability information, the target AMF 1104 may not transmit the K-bit request to the UDM 1108, even if the target AMF 1104 does not receive the information about the length of K from the source AMF 1106.

According to an embodiment, in operation 1130, the target AMF 1104 may receive an SDM response message from the UDM 1108. The SDM response message may or may not include information about the length of K. For example, when the K-bit request is included in the SDM request message, the SDM response message may include information about the length of K. For example, when the K-bit request is not included in the SDM request message, the SDM response message may not include information about the length of K. For example, regardless of whether the K-bit request is included in the SDM request message, the SDM request message may include information about the length of K.

According to an embodiment, in operation 1140, the target AMF 1104 may transmit a handover request message to a target gNB 1102. The handover request message transmitted by the target AMF 1104 to the target gNB 1102 may include at least one of information about UE security capability and information about the length of K. The information about the length of K of the UE 110 may be, e.g., the length of the algorithm used by the source gNB 802 with the UE 110 or may be provided using a separate parameter, provided through a separate indicator, or included in the UE security capability information. If the target AMF 1104 identifies that the length of K is 256 bits, the target AMF 1104 may modify UE security capability information (e.g., UE security capability information of FIG. 14) and transmit the modified UE security capability information to the target gNB 1102. For example, the target AMF 1104 may inform the target gNB 1102 that the length of K is 256 bits using a portion not used in the UE security capability information (e.g., at least one of the 5G-EA7 field of octet 3/5G-IA7 field of octet 4 of the UE security capability information of FIG. 14, the EEA7 field of octet 5/5G-EIA7 field of octet 6, or the empty fields of octet 7-10, or any other value).

According to an embodiment, in operation 1150, the target gNB 1102 may select an encryption algorithm and an integrity protection algorithm to be used for AS security configuration with the UE 110, based on the UE security capability information, the information about the length of K, and/or the information about the priority of the security algorithm of the target gNB 1102 received from the target AMF 1104.

The target gNB 1102 may select an algorithm to be used for the security algorithm with the UE 110. The target gNB 1102 may select an encryption algorithm and/or an integrity protection algorithm to be used for AS security configuration with the UE 110 based on the UE security capability information, the information about the length of the authentication key, and/or the information about the priority of the security algorithm of the target gNB 1102 received from the target AMF 1104. The target gNB 1102 may select an encryption algorithm and/or an integrity protection algorithm to be used for AS security configuration with the UE 110 based on the UE security capability information, the information about the length of the authentication key, and/or the information about the priority of the security algorithm of the target gNB 1102 received from the target AMF 1104.

The target gNB 1102 may select an encryption algorithm and/or an integrity protection algorithm to be used for AS security configuration with the UE 110. The target gNB 1102 may select the AS security algorithm based on UE security capability information included in the path-switch request acknowledge message or the handover request message, information about the length of K, and/or information about the algorithm priority of the target gNB 1102.

The target gNB 1102 may select an algorithm for AS security configuration with the UE 110. The target gNB 1102 may select an algorithm (hereinafter, referred to as “AS security algorithm”) for security configuration of the UE 110 and the target gNB 1102 based on at least one of information about the length of K, information about the priority of the algorithm for security configuration of the target gNB 1102 with the UE 110, or security capability information about the UE 110. The AS security algorithm may include an AS encryption algorithm and/or an AS integrity protection algorithm. The target gNB 1102 may include a list of AS encryption algorithms available to the target gNB 1102 and a list of AS integrity protection algorithms available to the target gNB 1102. The information about the priority of the AS security algorithm of the target gNB 1102 may indicate the information about the priority (which may have a form of, e.g., an order sorted in the list) between the plurality of algorithms included in the list of algorithms supportable by the target gNB 1102.

The target gNB 1102 may select an AS security algorithm based on the information about the length of K. For example, when the length of K is 128 bits, the target gNB 1102 may select a 128 bit-based algorithm. For example, when the length of K is 256 bits, the target gNB 1102 may select a 128 bit-based algorithm or a 256 bit-based algorithm. The algorithm for encryption and the algorithm for integrity protection may be algorithms based on the same or different numbers of bits.

The target gNB 1102 may select the AS security algorithm based on the information about the length of K and the information about the algorithm priority. For example, when it is identified that the length of K is 128 bits and the 128 bit-based algorithm has a higher priority than the 256 bit-based algorithm in the information about the algorithm priority, the target gNB 1102 may select the 128 bit-based algorithm. For example, when it is identified that the length of K is 128 bits and the 256 bit-based algorithm has a higher priority than the 128 bit-based algorithm in the information about the algorithm priority, the target gNB 1102 may select the 128 bit-based algorithm. For example, when it is identified that the length of K is 256 bits and the 256 bit-based algorithm has a higher priority than the 128 bit-based algorithm in the information about the algorithm priority, the target gNB 1102 may select the 256 bit-based algorithm. For example, when it is identified that the length of K is 256 bits and the 128 bit-based algorithm has a higher priority than the 256 bit-based algorithm in the information about the algorithm priority, the target gNB 1102 may select the 128 bit-based algorithm. In this case, because a 128 bit-based algorithm needs to be used, the target gNB 1102 may truncate to 128 bits when keys (e.g., K_{UPenc}, K_{UPint}, K_{RRCenc}, K_{RRCint}, etc.) generated as described below have a length of 256 bits. However, even if K has a length of 256 bits among the above-described examples, when the only algorithm included in the security capability information about the UE 110 is a 128 bit-based algorithm, the target gNB 1102 may select the 128 bit-based algorithm.

The target gNB 1102 may select the AS security algorithm based on the information about the length of K and/or the information about the security capability of the UE 110. For example, when the length of K is 128 bits and the UE 110 supports only the 128 bit-based algorithm, the target gNB 1102 may select the 128 bit-based algorithm. For example, when the length of K is 128 bits and the UE 110 supports the 128 bit-based algorithm and the 256 bit-based algorithm, the target gNB 1102 may select the 128 bit-based algorithm. Further, e.g., when the length of K is 256 bits and the UE 110 supports the 128 bit-based algorithm and the 256 bit-based algorithm, the target gNB 1102 may select the 128 bit-based algorithm or the 256 bit-based algorithm. In this case, the target gNB 1102 may select the 128 bit-based algorithm or the 256 bit-based algorithm based on the information about the security algorithm priority of the target gNB 1102. When the 256 bit-based algorithm has a higher priority than the 128 bit-based algorithm, the target gNB 1102 may select the 256 bit-based algorithm. When the 128 bit-based algorithm has a higher priority than the 256 bit-based algorithm, the target gNB 1102 may select the 128 bit-based algorithm.

The AS encryption algorithm and the AS integrity protection algorithm may be selected as the same or different. For example, the target gNB 1102 may select both the AS encryption algorithm and the AS integrity protection algorithm as 128 bit-based or 256 bit-based algorithms. For example, the target gNB 1102 may select the 128 bit-based algorithm as the AS encryption algorithm, and may select the 256 bit-based algorithm as the AS integrity protection algorithm. For example, the target gNB 1102 may select the 256 bit-based algorithm as the AS encryption algorithm, and may select the 128 bit-based algorithm as the AS integrity protection algorithm.

According to an embodiment, in operation 1160, the target gNB 1102 may transmit a handover command message including information about the selected algorithm to the UE 110.

Although not shown in the drawings, the target gNB 1102 may determine the handover of the UE 110 based on the measurement report received from the UE 110. Accordingly, a handover request message may be transmitted to another target gNB. In other words, in FIG. 11, the target gNB 1102 may also operate as a source gNB.

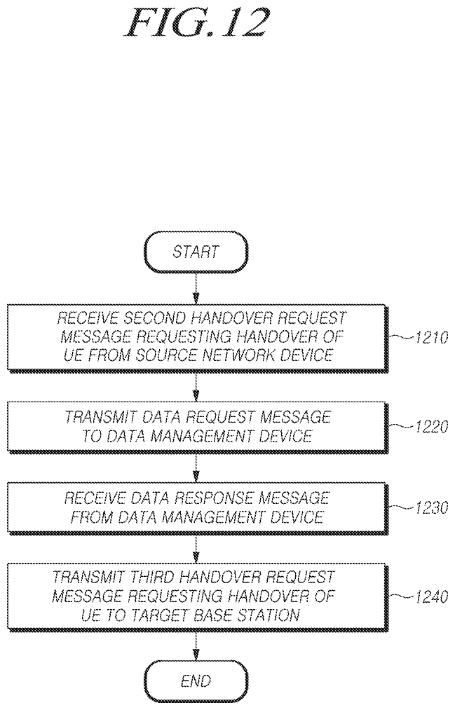

FIG. 12 illustrates an operation flow of a network device according to an embodiment of the disclosure.

FIG. 12 may include a description of the operation flow of the target AMF 1104 of FIG. 11. The network device of FIG. 12 may be the target AMF 1104 of FIG. 11, and the source network device may be a device corresponding to the source AMF 1106 of FIG. 11. The data management device of FIG. 12 may correspond to the UDM 1108 of FIG. 11. In the description of FIG. 12, the description overlapping those described with reference to FIG. 11 may be omitted.

Referring to FIG. 12, according to an embodiment, in operation 1210, a network device may receive an N2 handover request message from a source network device. Operation 1210 may include all of the operations of operation 1110 of FIG. 11. The N2 handover request message may include at least one of an algorithm for security configuration supported by the UE 110 and information about the length of K.

Although not illustrated in the drawings, the UE may transmit the measurement report to the source base station (e.g., the source gNB 802) connected to the UE. The source base station may determine the handover of the UE based on the measurement report received from the UE. When the source base station determines the handover of the UE, the source base station may transmit the handover request to the source network device. The source network device may transmit the handover request to the network device in response to receiving the handover request from the source base station.

According to an embodiment, in operation 1220, the network device may transmit a data request message to the data management device. The data management device may be a device corresponding to the UDM 1108 of FIG. 11. Operation 1220 may include the whole of operation 1120 of FIG. 11. When the N2 handover request message received from the source network device does not include the information about the length of the authentication key, the network device may request the data management device for the information about the length of the authentication key through the data request message. For example, when the handover request message received from the source network device does not include information about the length of the authentication key, the data request message may include a K-bit request for requesting information about the length of the authentication key. For example, when the handover request message received from the source network device includes information about the length of the authentication key, the data request message may not include a K-bit request.

When the network device does not receive the information about the length of the authentication key from the source network device even though it is identified that the UE supports the 256 bit-based algorithm in the UE security capability information, the network device may transmit the K-bit request to the data management device through the data request message. In an embodiment, when the network device identifies that the UE supports only the 128 bit-based algorithm in the UE security capability information, the network device may not transmit the K-bit request to the data management device even if information about the length of the authentication key is not received from the source network device.

According to an embodiment, in operation 1230, the network device may receive a data response message from the data management device. Operation 1230 may include an operation corresponding to operation 1130 of FIG. 11.

The data response message may or may not include information about the length of the authentication key. For example, when the K-bit request is included in the data request message, the data response message may include information about the length of the authentication key. For example, when the K-bit request is not included in the data request message, the data response message may not include information about the length of the authentication key. For example, regardless of whether the K-bit request is included in the data request message, the data request message may include information about the length of the authentication key.

According to an embodiment, in operation 1240, the network device may transmit a handover request message to the target base station. The handover request message transmitted from the network device to the target base station may include information about UE security capability and/or information about the length of the authentication key.

In an embodiment, although not shown in the drawings, the network device may then receive a handover request message for another UE from another base station. When the network device receives the handover request message from another base station, the network device may transmit the N2 handover request message to another AMF to be changed, such as the source network device described with reference to FIG. 12. In other words, in the description of FIG. 12, it is assumed that the network device is the target AMF, but the network device may also operate as the source AMF in another handover process.

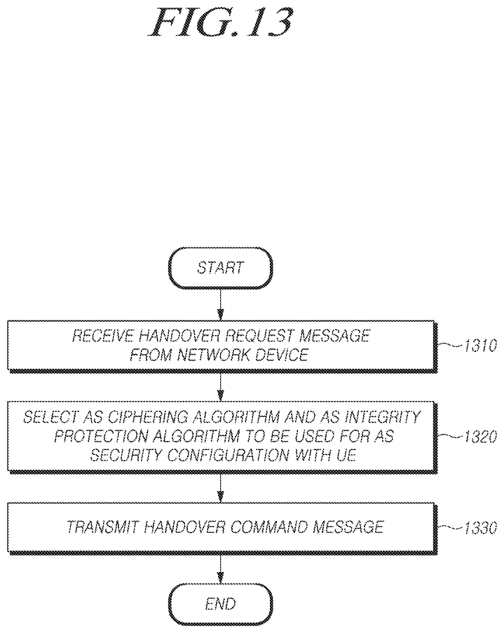

FIG. 13 illustrates an operation flow of a base station according to an embodiment of the disclosure.

The base station of FIG. 13 may correspond to the target gNB 1102 of FIG. 11. The network device of FIG. 13 may correspond to the target AMF 1104 of FIG. 11. The source network device of FIG. 13 may correspond to the source AMF 1106 of FIG. 11. The data management device of FIG. 13 may correspond to the UDM 1108 of FIG. 11.

Referring to FIG. 13, according to an embodiment, in operation 1310, a base station may receive a handover request message from a network device. Operation 1310 may include the whole of operation 1140 of FIG. 11. The handover request message transmitted from the network device to the base station may include information about UE security capability and/or information about the length of the authentication key.

According to an embodiment, in operation 1320, the base station may select the AS encryption algorithm and the AS integrity protection algorithm to be used for AS security configuration with the UE. Operation 1320 may include the whole of operation 1150. In operation 1330, the base station may transmit a handover command message including information about the selected algorithm to the UE 110.

The base station may select an encryption algorithm and an integrity protection algorithm to be used for AS security configuration with the UE, based on UE security capability information, information about the length of the authentication key, and information about the priority of the security algorithm of the base station received from the network device. The base station may select an encryption algorithm and an integrity protection algorithm to be used for AS security configuration with the UE based on the UE security capability information, the information about the length of the authentication key, and/or the information about the priority of the security algorithm of the base station received from the network device.

The base station may select an encryption algorithm and an integrity protection algorithm to be used for AS security configuration with the UE. The base station may select the AS security algorithm based on UE security capability information included in the path-switch request acknowledge message or the handover request message, information about the length of K, and/or information about the algorithm priority of the base station.

The base station may select an algorithm for AS security configuration with the UE. The base station may select an algorithm (hereinafter, referred to as “AS security algorithm”) for security configuration of the UE and the base station, based on at least one of information about the length of K, information about the priority of the algorithm for security configuration with the UE of the base station, or security capability information about the UE. The AS security algorithm may include an AS encryption algorithm and/or an AS integrity protection algorithm. The base station may include a list of AS encryption algorithms available to the base station and a list of AS integrity protection algorithms available to the base station. The information about the priority of the AS security algorithm of the base station may indicate the information about the priority (which may have a form of, e.g., an order sorted in the list) between the plurality of algorithms included in the list of algorithms supportable by the base station.

The base station may select an AS security algorithm based on the information about the length of K. For example, when the length of K is 128 bits, the base station may select a 128 bit-based algorithm. For example, when the length of K is 256 bits, the base station may select a 128 bit-based algorithm or a 256 bit-based algorithm. The algorithm for encryption and the algorithm for integrity protection may be algorithms based on the same or different numbers of bits.

The base station may select the AS security algorithm based on the information about the length of K and the information about the algorithm priority. For example, when it is identified that the length of K is 128 bits and the 128 bit-based algorithm has a higher priority than the 256 bit-based algorithm in the information about the algorithm priority, the base station may select the 128 bit-based algorithm. For example, when it is identified that the length of K is 128 bits and the 256 bit-based algorithm has a higher priority than the 128 bit-based algorithm in the information about the algorithm priority, the base station may select the 128 bit-based algorithm. For example, when it is identified that the length of K is 256 bits and the 256 bit-based algorithm has a higher priority than the 128 bit-based algorithm in the information about the algorithm priority, the base station may select the 256 bit-based algorithm. For example, when it is identified that the length of K is 256 bits and the 128 bit-based algorithm has a higher priority than the 256 bit-based algorithm in the information about the algorithm priority, the base station may select the 128 bit-based algorithm. In this case, because a 128 bit-based algorithm needs to be used, the base station may truncate to 128 bits when keys (e.g., K_{UPenc}, K_{UPint}, K_{RRCenc}, K_{RRCint}, etc.) generated as described below have a length of 256 bits. However, even if K has a length of 256 bits among the above-described examples, when the only algorithm included in the security capability information about the UE is a 128 bit-based algorithm, the base station may select the 128 bit-based algorithm.

The base station may select the AS security algorithm based on the information about the length of K and the information about the security capability of the UE. For example, when the length of K is 128 bits and the UE supports only the 128 bit-based algorithm, the base station may select the 128 bit-based algorithm. For example, when the length of K is 128 bits and the UE supports the 128 bit-based algorithm and the 256 bit-based algorithm, the base station may select the 128 bit-based algorithm. Further, e.g., when the length of K is 256 bits and the UE supports the 128 bit-based algorithm and the 256 bit-based algorithm, the base station may select the 128 bit-based algorithm or the 256 bit-based algorithm. In this case, the base station may select the 128 bit-based algorithm or the 256 bit-based algorithm based on the information about the security algorithm priority of the base station. When the 256 bit-based algorithm has a higher priority than the 128 bit-based algorithm, the base station may select the 256 bit-based algorithm. When the 128 bit-based algorithm has a higher priority than the 256 bit-based algorithm, the base station may select the 128 bit-based algorithm.

The AS encryption algorithm and the AS integrity protection algorithm may be selected as the same or different. For example, the base station may select both the AS encryption algorithm and the AS integrity protection algorithm as 128 bit-based or 256 bit-based algorithms. For example, the base station may select the 128 bit-based algorithm as the AS encryption algorithm, and may select the 256 bit-based algorithm as the AS integrity protection algorithm. For example, the base station may select the 256 bit-based algorithm as the AS encryption algorithm, and may select the 128 bit-based algorithm as the AS integrity protection algorithm.

In accordance with an aspect of the present disclosure, an embodiment of the present invention provides a method performed by a base station to select an access stratum (AS) security algorithm with a user equipment (UE), the method comprising: forwarding, by the base station to a network device, a registration request message received from the UE; receiving, by the base station from the network device, information about at least one security algorithm available to the UE and information about a length of an authentication key of the UE; selecting, by the base station, an AS ciphering algorithm and an AS integrity protection algorithm based on the information about the at least one security algorithm, the information about the length of the authentication key, and information about a security algorithm priority of the base station; and transmitting, by the base station to the UE, information about the selected AS ciphering algorithm and information about the selected AS integrity protection algorithm.

In an embodiment, wherein the information about the length of the authentication key includes an indicator indicating that the authentication key is either 128 bits or 256 bits, and wherein the information about the at least one security algorithm includes information about at least one of a 128 bit-based security algorithm and a 256 bit-based security algorithm.

In an embodiment, the method further comprising: receiving, by the base station from the UE, a measurement report; based on the measurement report, determining, by the base station, a handover of the UE; and in response to determining the handover of the UE, transmitting, by the base station to a target base station, a first handover request message, wherein the first handover request message includes at least one of the information about the length of the authentication key of the UE, the information about the at least one security algorithm, the information about the selected AS ciphering algorithm, or the information about the selected AS integrity protection algorithm.

In an embodiment, the method further comprising: receiving, by the base station from a source base station, a second handover request message requesting a handover of another UE; in response to receiving the second handover request message, transmitting, by the base station to an authentication server, a path-switch request message; receiving, by the base station from the authentication server, a path-switch request acknowledge message; and selecting, by the base station, an AS ciphering algorithm and an AS integrity protection algorithm to be used for AS security configuration with the another UE, wherein the second handover request message includes information about at least one security algorithm of the another UE, information about the AS ciphering algorithm and the AS integrity protection algorithm used for security configuration with the another UE, and information about a length of an authentication key of the another UE, and wherein the path-switch request message includes the information about the at least one security algorithm of the another UE and the information about the length of the authentication key of the another UE.

In accordance with another aspect of the present disclosure, another embodiment of the present invention provides a user equipment (UE) for performing network authentication, comprising: a subscriber identification module (SIM); communication circuitry; memory storing one or more computer programs; and one or more processors communicatively coupled to the SIM, the communication circuitry, and the memory, wherein the one or more computer programs include computer-executable instructions that, when executed by the one or more processors, cause the UE to: determine a K-bit identification indicator indicating whether a length of an authentication key (K) stored in the SIM is identified; select at least one security algorithm based on the K-bit identification indicator; and transmit, through the communication circuitry to a network device, a registration request message including the K-bit identification indicator and information about the at least one security algorithm.

In an embodiment, wherein the length of the authentication key is either 128 bits or 256 bits, and wherein the at least one security algorithm includes one or more of a security algorithm using a 128 bit-based key and a security algorithm using a 256 bit-based key.

In an embodiment, wherein the one or more computer programs further include computer-executable instructions that, when executed by the one or more processors, cause the UE to: request information about the length of the authentication key to the SIM; identify the length of the authentication key based on the information about the length of the authentication key in response to receiving the information about the length of the authentication key from the SIM; and determine that the length of the authentication key is not identified based on failing to receive the information about the length of the authentication key from the SIM.

In an embodiment, wherein the one or more computer programs further include computer-executable instructions that, when executed by the one or more processors, cause the UE to: select all of a plurality of security algorithms available to the UE in response to determining that the length of the authentication key is not identified; and select one or more security algorithms from among the plurality of security algorithms based on the length of the authentication key in response to identifying the length of the authentication key.

In an embodiment, wherein the one or more computer programs further include computer-executable instructions that, when executed by the one or more processors, cause the UE to: receive, through the communication circuitry, information about a selected security algorithm from a base station connected to the UE or the network device.

In accordance with another aspect of the present disclosure, another embodiment of the present invention provides a network device to select a non-access stratum (NAS) security algorithm with a user equipment (UE), the network device comprising: communication circuitry; memory storing one or more computer programs; and one or more processors communicatively coupled to the communication circuitry and the memory, wherein the one or more computer programs include computer-executable instructions that, when executed by the one or more processors, cause the network device to: receive, from the UE, a registration request message including information about at least one security algorithm and a K-bit identification indicator indicating whether the UE identifies a length of an authentication key (K), identify information about the length of the authentication key based on the information about the at least one security algorithm and the K-bit identification indicator, obtain the information about the length of the authentication key from an authentication server based on the length of the authentication key not being identified, and determine an NAS ciphering algorithm and an NAS integrity protection algorithm based on information about the length of the authentication key, information about the at least one security algorithm, and information about a security algorithm priority of the network device.

In an embodiment, wherein the one or more computer programs further include computer-executable instructions that, when executed by the one or more processors, cause the network device to: identify the information about the length of the authentication key based on the information about the at least one security algorithm in response to the K-bit identification indicator indicating that information about a length of the K is obtained from a subscriber identification module (SIM) of the UE.

In an embodiment, wherein the length of the authentication key is either 128 bits or 256 bits.

In an embodiment, wherein the one or more computer programs further include computer-executable instructions that, when executed by the one or more processors, cause the network device to: receive, from a base station through the communication circuitry, a handover request of the UE; and in response to receiving the handover request, transmit, through the communication circuitry to another network device, a first handover request message including at least one of the information about the at least one security algorithm or the information about the length of the authentication key.

In an embodiment, wherein the one or more computer programs further include computer-executable instructions that, when executed by the one or more processors, cause the network device to: receive, from another network device through the communication circuitry, a second handover request message requesting a handover of another UE, in response to receiving the second handover request message, transmit, to a data management device through the communication circuitry, a data request message, receive, from the data management device through the communication circuitry, a data response message, and transmit, to a target base station through the communication circuitry, a third handover request message requesting the handover of the another UE, wherein the second handover request message includes information about at least one security algorithm of the another UE and first information which is information about a length of an authentication key of the another UE, and wherein the third handover request message includes the information about the at least one security algorithm of the another UE and the first information.

In an embodiment, wherein, based on the data response message including second information about a length of an authentication key stored in the data management device, the third handover request message includes the second information.

In accordance with another aspect of the present disclosure, another embodiment of the present invention provides a base station to select an access stratum (AS) security algorithm with a user equipment (UE), the base station comprising: communication circuitry; memory storing one or more computer programs; and one or more processors communicatively coupled to the communication circuitry and the memory, wherein the one or more computer programs include computer-executable instructions that, when executed by the one or more processors, cause the base station to: forward, to a network device through the communication circuitry, a registration request message received from the UE, receive, from the network device through the communication circuitry, information about at least one security algorithm available to the UE and information about a length of an authentication key of the UE, select an AS ciphering algorithm and an AS integrity protection algorithm based on the information about the at least one security algorithm, the information about the length of the authentication key, and information about a security algorithm priority of the base station, and transmit, to the UE through the communication circuitry, information about the selected AS ciphering algorithm and information about the selected AS integrity protection algorithm.

In an embodiment, wherein the information about the length of the authentication key includes an indicator indicating that the authentication key is either 128 bits or 256 bits, and wherein the information about the at least one security algorithm includes information about at least one of a 128 bit-based security algorithm and a 256 bit-based security algorithm.

In an embodiment, wherein the one or more computer programs further include computer-executable instructions that, when executed by the one or more processors, cause the base station to: receive, from the UE through the communication circuitry, a measurement report, determine a handover of the UE based on the measurement report, and in response to determining the handover of the UE, transmit, to a target base station through the communication circuitry, a first handover request message, and wherein the first handover request message includes at least one of the information about the length of the authentication key of the UE, the information about the at least one security algorithm, the information about the selected AS ciphering algorithm, or the information about the selected AS integrity protection algorithm.

In an embodiment, wherein the one or more computer programs further include computer-executable instructions that, when executed by the one or more processors, cause the base station to: receive, from a source base station through the communication circuitry, a second handover request message requesting a handover of another UE; in response to receiving the second handover request message, transmit, to an authentication server through the communication circuitry, a path-switch request message; receive, from the authentication server through the communication circuitry, a path-switch request acknowledge message; and select an AS ciphering algorithm and an AS integrity protection algorithm to be used for AS security configuration with the another UE, wherein the second handover request message includes information about at least one security algorithm of the another UE, information about the AS ciphering algorithm and the AS integrity protection algorithm used for security configuration with the another UE, and information about a length of an authentication key of the another UE, and wherein the path-switch request message includes the information about the at least one security algorithm of the another UE and the information about the length of the authentication key of the another UE.

It should be noted that the configuration views, example views of control/data signal transmission/reception methods, and example views of operational procedures of FIGS. 1A, 1B, 2A, 2B, 2C, 3A, 3B, and 4 to 13 are not intended as limiting the scope of the disclosure. In other words, all the components, entities, or operational steps illustrated in FIGS. 1A, 1B, 2A, 2B, 2C, 3A, 3B, and 4 to 13 should not be construed as essential components to practice the disclosure, and the disclosure may be rather implemented with only some of the components without departing from the gist of the disclosure.

The operations of the above-described embodiments may be implemented by providing a memory device storing a corresponding program code in any component of the device. In other words, the controller in the device may execute the above-described operations by reading and executing the program codes stored in the memory device by a processor or central processing unit (CPU).

As described herein, various components or modules in the entity, or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for performing network authentication, the method comprising:
determining, by the UE, a K-bit identification indicator indicating whether a length of an authentication key (K) stored in a subscriber identification module (SIM) is identified;
selecting, by the UE, at least one security algorithm based on the K-bit identification indicator; and
transmitting, by the UE to a network device, a registration request message including the K-bit identification indicator and information about the at least one security algorithm.

2. The method of claim 1,
wherein the length of the authentication key is either 128 bits or 256 bits, and
wherein the at least one security algorithm includes one or more of a security algorithm using a 128 bit-based key and a security algorithm using a 256 bit-based key.

3. The method of claim 2, further comprising:
requesting, by the UE, information about the length of the authentication key to the SIM;
identifying, by the UE, the length of the authentication key based on the information about the length of the authentication key in response to receiving the information about the length of the authentication key from the SIM; and
determining, by the UE, that the length of the authentication key is not identified based on failing to receive the information about the length of the authentication key from the SIM.

4. The method of claim 3, wherein the selecting of the at least one security algorithm comprises:
in response to determining that the length of the authentication key is not identified, selecting, by the UE, all of a plurality of security algorithms available to the UE; and
in response to identifying the length of the authentication key, selecting, by the UE, one or more security algorithms from among the plurality of security algorithms based on the length of the authentication key.

5. The method of claim 1, further comprising:
receiving, by the UE from a base station connected to the UE or the network device, information about a selected security algorithm.

6. A method performed by a network device to select a non-access stratum (NAS) security algorithm with a user equipment (UE), the method comprising:
receiving, by the network device from the UE, a registration request message including information about at least one security algorithm and a K-bit identification indicator indicating whether the UE identifies a length of an authentication key (K);
identifying, by the network device, information about the length of the authentication key based on the information about the at least one security algorithm and the K-bit identification indicator;
obtaining, by the network device from an authentication server, the information about the length of the authentication key based on the length of the authentication key not being identified; and
determining, by the network device, an NAS ciphering algorithm and an NAS integrity protection algorithm based on information about the length of the authentication key, information about the at least one security algorithm, and information about a security algorithm priority of the network device.

7. The method of claim 6, wherein the identifying of the information about the length of the authentication key comprises:
identifying, by the network device, the information about the length of the authentication key based on the information about the at least one security algorithm in response to the K-bit identification indicator indicating that information about a length of the K is obtained from a subscriber identification module (SIM) of the UE.

8. The method of claim 7, wherein the length of the authentication key is either 128 bits or 256 bits.

9. The method of claim 6, further comprising:
receiving, by the network device from a base station, a handover request of the UE; and
in response to receiving the handover request, transmitting, by the network device to another network device, a first handover request message including at least one of the information about the at least one security algorithm or the information about the length of the authentication key.

10. The method of claim 6, further comprising:
receiving, by the network device from another network device, a second handover request message requesting a handover of another UE;
in response to receiving the second handover request message, transmitting, by the network device to a data management device, a data request message;
receiving, by the network device from the data management device, a data response message; and
transmitting, by the network device to a target base station, a third handover request message requesting the handover of the another UE,
wherein the second handover request message includes information about at least one security algorithm of the another UE and first information which is information about a length of an authentication key of the another UE, and
wherein the third handover request message includes the information about the at least one security algorithm of the another UE and the first information.

11. The method of claim 10, wherein, based on the data response message including second information about a length of an authentication key stored in the data management device, the third handover request message includes the second information.

12. A user equipment (UE) for performing network authentication, comprising:
a subscriber identification module (SIM);
communication circuitry;
memory storing one or more computer programs; and
one or more processors communicatively coupled to the SIM, the communication circuitry, and the memory,
wherein the one or more computer programs include computer-executable instructions that, when executed by the one or more processors, cause the UE to:
determine a K-bit identification indicator indicating whether a length of an authentication key (K) stored in the SIM is identified;
select at least one security algorithm based on the K-bit identification indicator; and
transmit, through the communication circuitry to a network device, a registration request message including the K-bit identification indicator and information about the at least one security algorithm.

13. The UE of claim 12,
wherein the length of the authentication key is either 128 bits or 256 bits, and
wherein the at least one security algorithm includes one or more of a security algorithm using a 128 bit-based key and a security algorithm using a 256 bit-based key.

14. The UE of claim 13, wherein the one or more computer programs further include computer-executable instructions that, when executed by the one or more processors, cause the UE to:
request information about the length of the authentication key to the SIM;
identify the length of the authentication key based on the information about the length of the authentication key in response to receiving the information about the length of the authentication key from the SIM; and
determine that the length of the authentication key is not identified based on failing to receive the information about the length of the authentication key from the SIM.

15. The UE of claim 14, wherein the one or more computer programs further include computer-executable instructions that, when executed by the one or more processors, cause the UE to:
select all of a plurality of security algorithms available to the UE in response to determining that the length of the authentication key is not identified; and
select one or more security algorithms from among the plurality of security algorithms based on the length of the authentication key in response to identifying the length of the authentication key.

16. The UE of claim 12, wherein the one or more computer programs further include computer-executable instructions that, when executed by the one or more processors, cause the UE to:
receive, through the communication circuitry, information about a selected security algorithm from a base station connected to the UE or the network device.

17. A network device to select a non-access stratum (NAS) security algorithm with a user equipment (UE), the network device comprising:
communication circuitry;
memory storing one or more computer programs; and
one or more processors communicatively coupled to the communication circuitry and the memory,
wherein the one or more computer programs include computer-executable instructions that, when executed by the one or more processors, cause the network device to:
receive, from the UE, a registration request message including information about at least one security algorithm and a K-bit identification indicator indicating whether the UE identifies a length of an authentication key (K),
identify information about the length of the authentication key based on the information about the at least one security algorithm and the K-bit identification indicator,
obtain the information about the length of the authentication key from an authentication server based on the length of the authentication key not being identified, and
determine an NAS ciphering algorithm and an NAS integrity protection algorithm based on information about the length of the authentication key, information about the at least one security algorithm, and information about a security algorithm priority of the network device.

18. The network device of claim 17, wherein the one or more computer programs further include computer-executable instructions that, when executed by the one or more processors, cause the network device to:
identify the information about the length of the authentication key based on the information about the at least one security algorithm in response to the K-bit identification indicator indicating that information about a length of the K is obtained from a subscriber identification module (SIM) of the UE.

19. The network device of claim 18, wherein the length of the authentication key is either 128 bits or 256 bits.

20. The network device of claim 17, wherein the one or more computer programs further include computer-executable instructions that, when executed by the one or more processors, cause the network device to:
receive, from a base station through the communication circuitry, a handover request of the UE; and
in response to receiving the handover request, transmit, through the communication circuitry to another network device, a first handover request message including at least one of the information about the at least one security algorithm or the information about the length of the authentication key.
